(19) United States
(12) Patent Application Publication
(10) Pub. No.: US 2025/0131234 A1
(43) Pub. Date: Apr. 24, 2025

(54) SYSTEMS AND METHODS FOR INTERFACING NATURAL INTELLIGENCE WITH ARTIFICIAL INTELLIGENCE

(71) Applicant: University of Florida Research Foundation, Incorporated, Gainesville, FL (US)

(72) Inventors: Swarup Bhunia, Gainesville, FL (US); Rohan Kalavakonda, Gainesville, FL (US); Aritra Dasgupta, Gainesville, FL (US); Archit Jaiswal, Gainesville, FL (US); Junjun Huan, Gainesville, FL (US); Peyman Dehghanzadeh, Gainesville, FL (US)

(21) Appl. No.: 18/916,901

(22) Filed: Oct. 16, 2024

Related U.S. Application Data
(60) Provisional application No. 63/591,527, filed on Oct. 19, 2023.

(51) Int. Cl. G06N 3/006

(52) U.S. Cl. CPC G06N 3/006

(57) ABSTRACT

A fusion intelligence system comprising a natural intelligence (NI) subsystem coupled to an artificial intelligence (AI) subsystem. The NI subsystem comprises sensors or actuators that are configured to interface with natural beings. The NI subsystem is configured to collect data from a physical environment and transmit the data to the AI system for training one or more AI models that are configured to monitor and control the NI subsystem.

### CROSS REFERENCE TO RELATED APPLICATION

This application claims the priority of U.S. Provisional Application No. 63/591,527, entitled “SYSTEMS AND METHODS FOR INTERFACING NATURAL INTELLIGENCE WITH ARTIFICIAL INTELLIGENCE,” filed on Oct. 19, 2023, the disclosure of which is hereby incorporated by reference in its entirety.

### TECHNICAL FIELD

Various embodiments of the present disclosure relate to artificial intelligence, and more particularly to enhancing artificial intelligence with natural intelligence capabilities in Internet of things (IoT) systems.

### BACKGROUND

Sensors may be configured to convert stimuli from the physical world into digital data, and conversely, actuators may be configured to allow the digital world to interact with the physical world. By combining sensors and actuators with smart systems including artificial intelligence (AI), useful information may be extracted and used to automate interactions with the physical environment. Computing hardware advancements have made it possible for AI systems to work in real time. For example, data from sensors can be used by AI algorithms to make quick decisions. However, AI cannot understand and apply general knowledge or common sense. As such, the ability of AI to interact with the world rationally is limited and requires help reacting to unseen scenarios. AI generally operates as black boxes, making it difficult to understand how or why a particular decision was made, and thus creates a challenge for iteratively optimizing the AI. The ability of AI to make a decision is as good as the data it is trained on. However, due to the black box of AI, difficulties arise in how to effectively tune the dataset without significant resource overhead, thus resulting in AI systems that are yet to reach their potential.

While significant advances have been made in sensory technologies, there are still limitations to their range, resolution, accuracy, and ability to work in adverse conditions. Most sensor systems comprise a tradeoff between the aforementioned metrics. Many state-of-the-art sensory systems and AI systems consume a lot of energy and require large memory requirements. Thus, implementing a complex system at the “edge” (or perception layer) is often not possible. Furthermore, individual sensors in sensory systems are rarely capable of performing complex processing of collected data or making swift decisions.

There is a need for addressing the limitations of existing “IoT-Edge” sensor systems that rely on AI for decision making in real-time.

### BRIEF SUMMARY

Various embodiments described herein relate to a fusion intelligence system comprising a natural intelligence (NI) subsystem coupled to an artificial intelligence (AI) subsystem.

According to some embodiments, a system is provided. In some embodiments, the system comprises one or more natural intelligence (NI) subsystems that comprise one or more sensors and one or more actuators, wherein the one or more NI subsystems are configured to (i) generate sensor data that is associated with one or more responses of one or more natural beings to one or more stimuli via the one or more sensors and (ii) manage the one or more natural beings based on one or more instructions via the one or more actuators; and one or more artificial intelligence (AI) subsystems that are coupled to the one or more NI subsystems, wherein the one or more AI subsystems comprise one or more AI machine learning models that are configured to (i) receive the sensor data from the one or more NI subsystems and (ii) generate the one or more instructions based on the sensor data.

In some embodiments, the one or more NI subsystems are configured to digitize one or more actions or responses of the one or more natural beings to the one or more stimuli. In some embodiments, the one or more AI machine learning models are trained to interpret actions associated with the sensor data. In some embodiments, the one or more AI subsystems are configured to monitor the one or more NI subsystems by correlating activity associated with the sensor data with a quantized unit of change in a measured physical phenomenon associated with the one or more stimuli. In some embodiments, the one or more AI subsystems are coupled to the one or more NI subsystems in a one-to-one configuration, a plurality of AI subsystems to one NI subsystem configuration, a one AI subsystem to a plurality of NI subsystem configuration, or a plurality of AI subsystems to a plurality of NI subsystems configuration. In some embodiments, the one or more AI subsystems are configured in an AI monitoring NI configuration and comprises a model supervisor that is configured to train a monitoring AI machine learning model from the one or more AI machine learning models based on the sensor data. In some embodiments, the monitoring AI machine learning model is trained to monitor and provide an estimated meaningful observation of activity or behavior that is associated with the sensor data. In some embodiments, the one or more AI subsystems are configured in an AI controlling NI configuration and comprises a model supervisor that is configured to (i) train a controlling AI machine learning model based on output from a monitoring AI machine learning model and (ii) generate, using the controlling AI machine learning model the one or more instructions.

According to some embodiments, the system comprises a perception layer that comprises a natural intelligence (NI) subsystem that interfaces with one or more natural beings via one or more sensors and one or more actuators; a processing layer that comprises an artificial intelligence (AI) subsystem configured to (i) receive data from the NI subsystem and (ii) train one or more AI machine learning models to monitor or control the NI subsystem based on the data; a network layer that is configured to provide the data from the NI subsystem to the AI subsystem; and an application layer that is configured to (i) provide one or more inputs to the AI subsystem for processing by the one or more AI machine learning models and (ii) provide an interface for interacting with output generated by the one or more AI machine learning models based on the one or more inputs.

In some embodiments, the NI subsystem is configured to collect data from a physical environment or interact with a physical world via the one or more natural beings by using the one or more sensors. In some embodiments, the AI subsystem is further configured to train the one or more AI machine learning models to (i) understand or predict behavior of the one or more natural beings and (ii) generate one or more instructions to control the one or more natural beings via the one or more actuators. In some embodiments, the NI subsystem comprises a natural beings hosting component that is configured to maintain the natural beings. In some embodiments, the one or more sensors are configured to generate the data based on a response of the one or more natural beings to one or more stimuli. In some embodiments, the data is associated with one or more physical phenomena. In some embodiments, a monitoring AI machine learning model of the one or more AI machine learning models is trained to generate an output in response to a change in a physical phenomenon based on sensing data generated by the one or more sensors with respect to the natural beings. In some embodiments, the one or more actuators are configured to manage the natural beings based on the output. In some embodiments, a controlling AI machine learning model of the one or more AI machine learning models is configured to generate one or more instructions based on the output. In some embodiments, the AI subsystem is configured to provide the one or more instructions to the one or more actuators. In some embodiments, the one or more sensors comprise one or more infrared cameras or one or more wide-frequency-range tuned microphones. In some embodiments, the one or more actuators comprise one or more speakers, one or more light-emitting diodes, one or more olfactory synthesizers, or one or more food dispensers.

### BRIEF DESCRIPTION OF THE DRAWINGS

Embodiments incorporating teachings of the present disclosure are shown and described with respect to the figures presented herein.

FIG. 1A illustrates an example Internet of things (IoT) system.

FIG. 1B illustrates an example fusion intelligence (FI) system in accordance with some embodiments discussed herein.

FIG. 2 illustrates a block diagram of an FI system in accordance with some embodiments discussed herein.

FIG. 3 illustrates an example system with an FI architecture in accordance with some embodiments discussed herein.

FIG. 4 illustrates an example architectural block diagram of an FI system in accordance with some embodiments discussed herein.

FIG. 5 illustrates an architectural block diagram of an NI subsystem in accordance with some embodiments discussed herein.

FIG. 6 illustrates an architectural block diagram of an AI subsystem in accordance with some embodiments discussed herein.

FIG. 7A is a diagram of an example FI system in accordance with some embodiments of the present disclosure.

FIG. 7B is a diagram of an example FI system in accordance with some embodiments of the present disclosure.

FIG. 7C is a diagram of an example FI system in accordance with some embodiments of the present disclosure.

FIG. 7D is a diagram of an example FI system in accordance with some embodiments of the present disclosure.

FIG. 8 depicts an architectural block diagram of an example AI subsystem in an AI monitoring NI configuration in accordance with some embodiments discussed herein.

FIG. 9 depicts an architectural block diagram of an example AI subsystem in an AI controlling NI configuration in accordance with some embodiments discussed herein.

FIG. 10A depicts an example process for processing sensor data in accordance with some embodiments discussed herein.

FIG. 10B depicts an example process for processing actuator instructions in accordance with some embodiments discussed herein.

FIG. 11A, 11B, 11C illustrate an example flow chart of a process performed by an AI subsystem in accordance with some embodiments discussed herein.

FIG. 12 depicts an example process for configuring an FI system in accordance with some embodiments discussed herein.

FIGS. 13A, 13B, 13C, 13D, 13E, and 13F illustrate an example process for detecting invasive species in accordance with some embodiments discussed herein.

FIG. 14 depicts an example feedback device in accordance with some embodiments discussed herein.

FIG. 15 depicts a flowchart of an example system architecture of invasive species detection and its feedback path in accordance with some example embodiments discussed herein.

FIG. 16 depicts an example system architecture of landmine detection using bees in accordance with some example embodiments discussed herein.

FIG. 17 illustrates conditioning for training an individual bee to associate trinitrotoluene (TNT) vapors with reward (nectar) in accordance with some example embodiments discussed herein.

FIG. 18 depicts components of an example FI system in accordance with some example embodiments discussed herein.

FIG. 19 represents the block diagram of the AI subsystem implemented to monitor and control the bee visitation to enhance pollination over the targeted field.

FIG. 20 illustrates a system architecture of drug testing using ants' sense of smell in accordance with some example embodiments discussed herein.

FIG. 21 illustrates a system architecture of drug detection in post office using bees' natural intelligence in accordance with some example embodiments discussed herein.

FIG. 22 illustrates a low concentration of bees around packages inside a chamber in accordance with some example embodiments discussed herein.

FIG. 23 illustrates a high concentration of bees around packages inside a chamber in accordance with some example embodiments discussed herein.

FIG. 24 and FIG. 25 illustrate conventional package screening technology in conjunction with natural intelligence in accordance with some example embodiments discussed herein.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

Embodiments of the present disclosure provide a fusion intelligence (FI) system capable of addressing the limitations of existing Internet of things (IoT)-edge sensor systems that rely on artificial intelligence (AI) for decision making in real-time. The disclosed FI system may comprise a natural intelligence (NI) component and an AI component that operate in tandem.

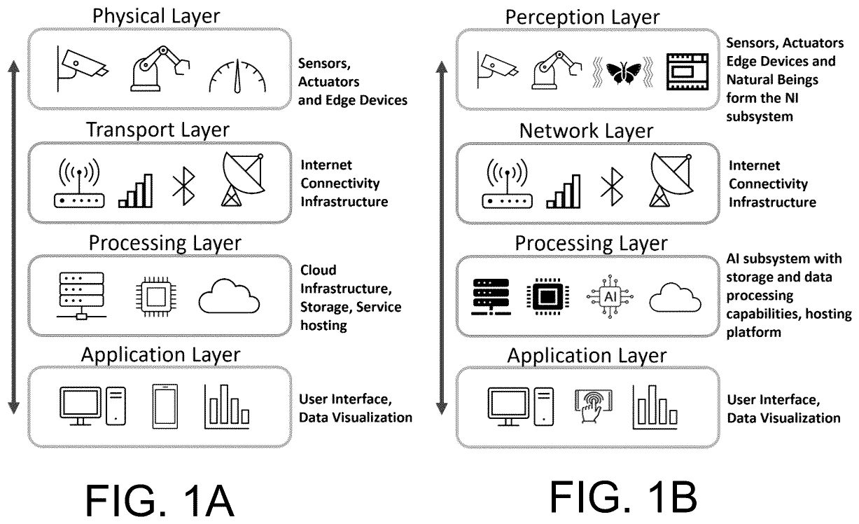

In current IoT systems, sensors and actuators may be communicatively coupled to a cloud infrastructure through an Internet gateway (IG) to relay information to processing units hosted elsewhere. As depicted in FIG. 1A, an example IoT system comprises a physical layer, a transport layer, a processing layer, and an application layer. The physical layer may comprise devices configured to interface with a physical environment, such as sensors, actuators, and edge devices. The transport layer may comprise network and communication components, such as Internet connectivity infrastructure configured to transmit data between the layers of the IoT system. The processing layer may comprise computing components, either physical or as a service, such as cloud infrastructure, storage, and service hosting. The application layer may comprise input/output hardware and/or hardware, such as user interfaces and data visualization, which allow users to interact with the IoT system.

The configuration depicted in FIG. 1A introduces a delay in the response generated at the physical layer as data is sent to processing nodes in the cloud of the processing layer. Such processing nodes in the processing layer may send back signals to the physical layer for actuators to react accordingly. Edge devices may be introduced in the physical layer to offload some of the processing from cloud of the processing layer. However, edge devices often are not as powerful as their cloud hosted counterparts.

According to various embodiments of the present disclosure, an FI system may be configured to generate instantaneous responses in complex situations, as depicted in FIG. 1B, by integrating NI subsystems with AI to interface natural beings with IoT systems. For example, an NI subsystem may comprise devices (e.g., sensors, actuators and edge devices) that may be configured harvest data from and direct natural beings, such as insects, to perform actions. As such, intelligence and sensory capabilities of natural beings, which surpasses traditional electromechanical systems' sophistication and energy efficiency, may be imparted onto a computing system. Accordingly, an FI system may leverage the biological traits of living beings to overcome the limitations of current sensor systems and AI, resulting in synergy between NI and AI for more efficient and responsive IoT systems.

In some embodiments, the FI system comprises a perception layer, a network layer, a processing layer, and an application layer. The perception layer may comprise an NI subsystem that is configured to interface with natural beings via devices, such as sensors, actuators, and edge devices. The network layer may comprise network and communication components, such as Internet connectivity infrastructure configured to transmit data between the layers of the FI system. The processing layer may comprise computing components, either physical or as a service, such as cloud infrastructure, storage, and service hosting. The application layer may comprise input/output hardware and/or hardware, such as user interfaces and data visualization, which allow users to interact with the FI system.

Various embodiments of the present disclosure make important technical contributions to improving speed and operation of computing systems by combining AI with NI.

In some embodiments, an FI system is configured to integrate AI with natural sensory abilities of living beings, such as insects, to create an intelligent system comprising living being-like perception. As such, the disclosed FI systems may possess advanced vision, smell, and hearing capabilities, enabling the FI systems to detect and analyze a wide range of environmental cues, which may not be possible using sensor devices alone. In some embodiments, an FI system is configured to integrate AI with NI abilities, such as physical strength, flight, swift movement, swimming, and endurance (e.g., long-distance travel), without expending extensive energy or deploying mechanically complex structures. Through the integration of AI with NI, the disclosed perception layer devices may outperform electromechanical actuators alone, resulting in superior performance and efficiency across various applications.

The disclosed FI system may further enable symbiotic relationships between different biological entities, facilitated by AI which otherwise may not be naturally possible. In some embodiments, AI may be used to analyze data to understand the intricate dynamics between species. By integrating AI into natural species interactions, real-time decisions may be determined to maintain, enhance, and/or optimize symbiotic interactions between species.

In some embodiments, an FI system comprises AI that is configured to learn (e.g., trained with data obtained from sensors) from nature to adapt and react automatically to changes in the FI system's surroundings, allowing the FI system to operate independently without needing constant user adjustments, thereby enabling the FI system to become efficient and self-sufficient. In some embodiments, an FI system may be configured according to user-specific needs by establishing and configuring multiple NI-AI subsystems. In n some embodiments, electromechanical sensors and actuators may be deployed to interface with natural beings to provide enhance adaptability and versatility for a wide range of applications.

In some embodiments, an FI system may comprise bio-memory that is representative of evolutionary traits developed by natural beings. According to various embodiments of the present disclosure, bio-memory may outperform training datasets for training AI machine learning models. That is, by combining NI and AI, AI machine learning models may be empowered with experiences and genetically evolved traits for enhancing problem-solving capabilities, predictions, and overall performance of the AI machine learning models. In some example embodiments, an FI system utilizes AI algorithms that are based on foraging behavior of insects to achieve efficient resource allocation in complex computational systems. In some example embodiments, an FI system utilizes AI algorithms that are based on social cognition to optimize for improved efficiency and performance by emulating cooperative harmony found in insect colonies. By emulating decentralized decision-making processes of insects, algorithms may be developed to optimize energy consumption, logistics, and distribution networks, resulting in enhanced resource utilization and improved overall system performance.

In some embodiments, an FI system may be configured to performed distributed problem-solving processing for computing tasks where a single AI machine learning model may lack necessary expertise to solve complex problems. For example, by integrating multiple AI machine learning models, each with unique strengths and domain-specific knowledge provided by connected NI subsystems, an FI system may harness collective intelligence from the multiple AI machine learning models to solve intricate tasks effectively. Via such a distributed problem-solving processing approach, a plurality of AI machine learning models may be configured to collaborate and complement each other's weaknesses, resulting in more accurate and comprehensive solutions for a wide range of problem-solving tasks.

In some embodiments, an FI system may be configured to merge spatial cognition of NI with AI algorithms to develop navigation systems with efficient and adaptive routing capabilities. Accordingly, the disclosed FI system may improve autonomous vehicles, logistics, and transportation networks by harnessing navigation abilities of natural beings in diverse and dynamic environments.

In some embodiments, an FI system may comprise a plurality of NI that is configured to communicate with and instruct a plurality of natural beings to unify and achieve a complex goal. For example, by working together, a plurality of natural beings may combine their sensing strength, decision-making, and/or problem-solving abilities to improve overall performance. By deploying thousands of smaller natural beings, such as insects, the disclosed FI system may gain redundancy to increase fault tolerance and ensure reliable and robust operation.

In some embodiments, an FI system may leverage collective intelligence and/or learning by interacting with a plurality of genetically diverse natural beings for sensing. For example, data may be gathered via sensors from the plurality of genetically diverse natural beings and used to enhance an AI's contextual understanding, improve feature extraction for datasets, and increase data points for accurate statistical analysis, thereby resulting in more effective and advanced AI training.

In some embodiments, an FI system may take advance of extreme resilience of natural beings that have evolved to thrive in harsh environments. For example, an FI system may be able to function in challenging conditions by interfacing with natural beings that have acclimated to such challenging conditions, thereby offering a robust and reliable computing system even in extreme temperatures or hostile environments.

In some embodiments, an FI system may capitalize on natural energy efficiency of insects' sensory organs. For example, natural beings, such as insects, have evolved to thrive on minimal energy resources while developing extraordinary sensory organs, such as compound eyes and antennae. By incorporating natural being energy-efficient sensory mechanisms with AI, an FI system may operate intelligent sensing and actuation operations for extended periods using substantially lower energy. Energy consumption of ants and bees compared with example electromechanical systems are depicted in Table 1.

TABLE 1

| | Power | | | | | |
|---|---|---|---|---|---|---|
| Devices | Consumption | Runtime | | Energy (Whr) | Energy (Cal) | |
| Biosensors/pacemaker | 1 uW to 1 mW | 1 | hr | 1 uWhr-1 mWhr | 86 mCal-0.8 Cal | |
| Medical Implants | 1 mw to 1 W | 1 | hr | 1 mWhr-1 Whr | 0.8 Cal-860 Cal | |
| Ventricular Assist | 25 W | 1 | hr | 25 Whr | 21.5 | KCal |
| Device | | | | | | |
| IoT system with a | 5 W to 25 W | 1 | hr | 5 Whr-25 Whr | 4.3 KCal-21.5 KCal | |
| camera & a single-board | | | | | | |
| computer | | | | | | |
| Powerful IoT Systems | 65 W to 100 W | 1 | hr | 65 Whr-100 Whr | 56 KCal-86 KCal | |
| Ant | | 180 | Days | | 1.36 | Cal |
| Entire Bee colony | | 1 | Day | | 1.6 | KCal |

In some embodiments, an FI system may comprise AI machine learning models that are trained with data based on unbiased, intelligent decisions of natural beings, such as insects. That is, natural beings may make decisions based on biological mechanisms and may thereby provide raw, objective data directly from their environment.

In some embodiments, an FI system may capitalize on the advantageous form factor of natural beings, such as insects. For example, by deploying tiny, autonomous sensing, and actuating natural beings via an NI subsystem, hard-to-reach spaces can be navigated and accessed without majorly disrupting the surroundings. With AI remotely instructing NI, FI systems may be created to offer intelligent and unobtrusive solutions for various applications.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

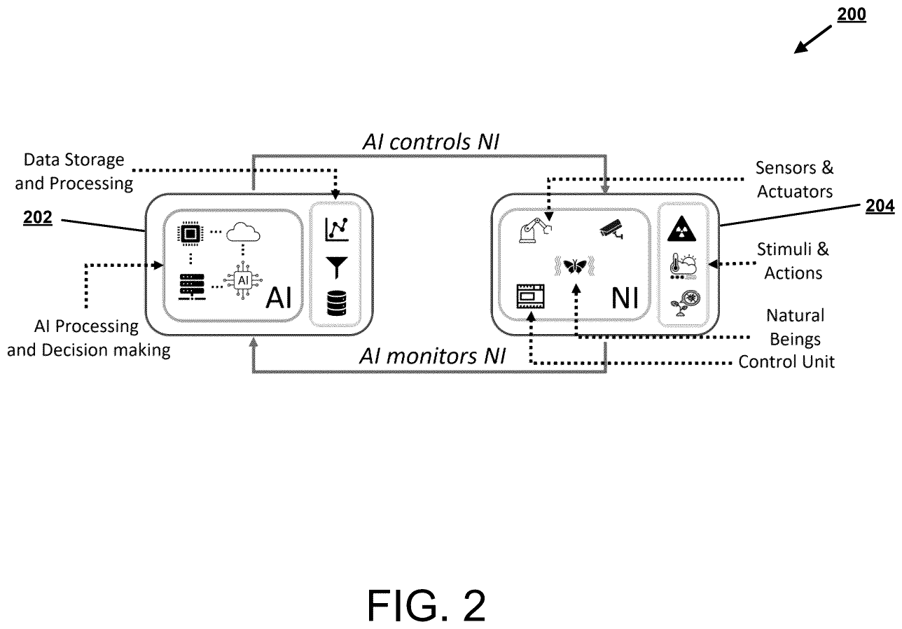

FIG. 2 depicts a block diagram of an example FI system 200 in accordance with some embodiments discussed herein. The FI system 200 may comprise closed-loop feedback paths between an AI subsystem 202 and an NI subsystem 204 to let the FI system 200 self-configure and operate autonomously while accommodating user intervention as required. The NI subsystem 204 may comprise devices (e.g., sensors and actuators) communicatively coupled to a control unit and configured to receive stimuli and/or perform actions via natural beings. The AI subsystem 202 may comprise AI processing and decision-making elements (e.g., hardware, software, or a combination thereof) configured to perform data storage and processing of data received from the NI subsystem 204 (e.g., associated with stimuli) and instruct the NI subsystem 204 to perform actions based on the processing of data.

The NI subsystem 204 may be configured with circuitry that digitalizes actions and responses of natural beings to stimuli. When natural beings interact with a stimulus, they may instinctively respond to it, and the NI subsystem 204 may comprise a sensor suite configured to record this response. The recorded data may then be transmitted to the AI subsystem 202 for processing. The AI subsystem 202 may be configured to filter and use this data for training AI machine learning models or extracting real-time information, which in turn may instruct actuators to perform specific actions through the NI subsystem 204. The NI subsystem 204 may be deployed for both sensing and actuating. The NI subsystem 204 may comprise electromechanical sensors and actuators that may be utilized to capture responses of natural beings and to manage the beings' activity per user requirements, respectively. In some embodiments, several mechanisms may be employed to control natural beings, such as treats that may be used to condition the natural beings. In some embodiments, controlling or conditioning natural beings may be automated with an electromechanical sensor-actuator suite to improve efficiency and adapt the NI subsystem 204 on the go for many applications, making the NI subsystem a versatile and dynamic component of the FI system 200.

Natural beings, unlike machines, may naturally respond to basic environmental changes without requiring external instructions. As a result, the need for high-fidelity real-time processing at the perception layer can be minimized, allowing these resources to be allocated to tasks that directly impact the system's effectiveness.

Various species have developed mechanisms that help them adapt to varying environmental conditions, such as hunting prey or surviving predators. In some embodiments, the FI system 200 may utilize natural instincts of beings to sense physical parameters efficiently. Genetical traits and instincts obtained through millions of years of evolution are superior to any AI training dataset created. Hence, interaction with natural beings by the NI subsystem 204 may be associated with edge device sensing and actuating. For example, a dog can sniff an object more quickly than any individual sensor. That is, a sensor may be paired with complex computing resources to extract meaningful information from the data collected. Building a robot that can move independently and sniff out an object of interest may require hundreds of complex algorithms to run in real time, which may require powerful computing resources and sensing technologies that consume a lot of energy. The robot may also need to be constantly charged (e.g., to keep the batteries from running low) or powered and may be costly to replicate some of the dog's abilities. Meanwhile, a dog can navigate intricate pathways solving complex problems and identify an object by sniffing effortlessly. Thus, it may be impractical to build a robot for the situation, given the availability of a sniffer dog.

Target stimuli may dictate the selection of sensors and the development of subsequent support frameworks in an IoT model. Similarly, species best suited for a required stimulus may be selected for specific applications. An observation may be made on how the selected beings respond to the stimulus and the FI system 200 with infrastructure supporting the NI subsystem 204 may be created based on the response. Sensors may be selected based on a physical response exhibited by the natural beings associated with the NI subsystem 204. Suitable actuators that manage the behavior of natural beings in the NI subsystem 204 may be configured to manage the beings' behavior according to application needs. The selected sensors may collect data on how the beings respond to the stimuli and solve corresponding challenges of varying environmental conditions where the beings are deployed. The collected data may be sent to the AI subsystem 202 for training to interpret actions of the natural beings from sensor data associated with the NI subsystem 204.

The AI subsystem 202 may be configured to monitor the NI subsystem 204 and generate output by correlating activity associated with sensor data from the NI subsystem 204 with a quantized unit of change in a measured physical phenomenon. An AI machine learning model may be configured to generate instructions that can be translated to signals for actuators in the NI subsystem 204. The AI subsystem 202 may direct the beings in the NI subsystem 204 through the actuators and manage the NI subsystem 204 resources to suit the intended application. According to various embodiments of the present disclosure, the FI system 200 may be configured to sense and actuate autonomously to solve a problem for a designated application, thereby making the FI system 200 incredibly effective compared to convention IoT systems.

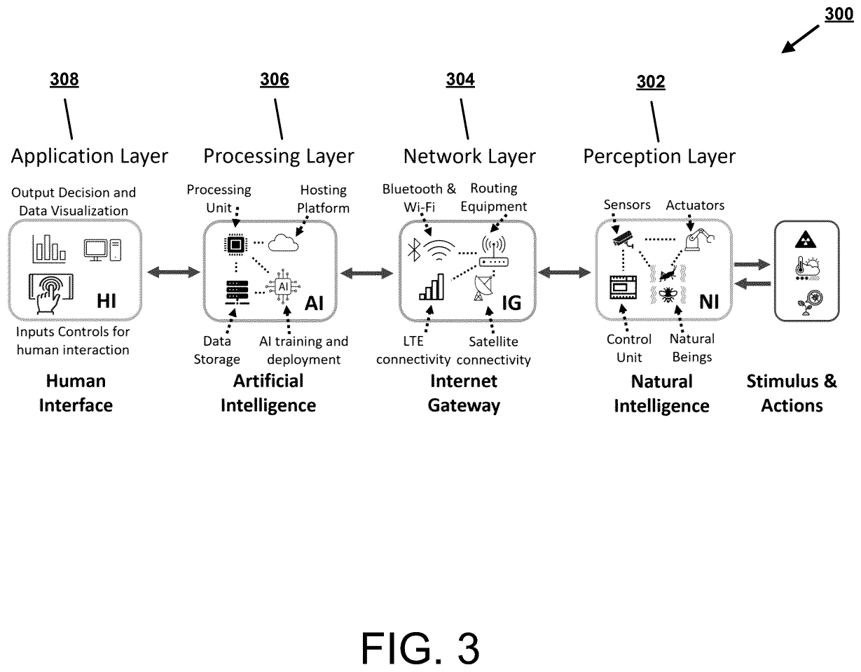

FIG. 3 depicts an example IoT system 300 that is based on an FI architecture in accordance with some embodiments discussed herein. The IoT system 300 comprises a perception layer 302, a network layer 304, a processing layer 306, and an application layer 308. The perception layer 302 comprises an NI subsystem that interfaces with natural beings via sensors and actuators that are coupled to a control unit. Natural beings may be used to function as sensors or actuators, along with a supporting electromechanical sensor and actuator devices that may reside in the NI subsystem. The NI subsystem may be responsible for collecting data from the physical environment or interacting with the physical world via the natural beings using the electromechanical sensor and actuator devices. The NI subsystem may comprise a control unit that is analogous to an edge device that translates NI behavior/activity into digital data.

The processing layer 306 comprises an AI subsystem (e.g., processing unit, hosting platform, data storage, and AI training and deployment). Data from the NI subsystem may be ingested into storage devices hosted in the AI subsystem. The data may then be processed and used to train AI machine learning models responsible for monitoring and controlling the NI subsystem. Information from NI data can be used for training the AI machine learning models to understand and predict the behavior of natural beings interfaced with the NI subsystem. Data may flow bidirectionally with feedback and feedforward loops between the AI and NI subsystems, as depicted in FIG. 2. Understanding responses to stimuli via the NI subsystem may also allow AI machine learning models to make decisions (e.g., generate instructions for controlling the natural beings via actuator devices). As an AI machine learning model gets trained on data, it can send instructions to the NI subsystem when deployed in the field. Beings associated with the NI subsystem may be configured to act as actuators, and thus instructions sent from the AI subsystem may be crucial in ensuring the IoT system 300 runs autonomously without constant human intervention.

The application layer 308 and the network layer 304 comprise human interface (HI) and Internet gateway (IG) subsystems, respectively. The HI and IG subsystems may comprise support systems for the IoT system 300 to function, e.g., as a complete IoT ecosystem. The IG subsystem (e.g., Bluetooth and Wi-Fi devices, routing equipment, cellular connectivity devices, or satellite connectivity devices) may be configured to host network infrastructure responsible for transporting data between the AI and NI subsystems. Depending on the deployment, the IG subsystem may be configured with wireless and wired connectivity. The AI subsystem may be interconnected with the NI subsystem through the IG subsystem. The IG subsystem may facilitate a connection and data flow between the subsystems of the IoT system 300. The IG subsystem may also be responsible for maintaining and establishing communication between/among multiple NI and AI subsystems deployed in the IoT system 300. The IG subsystem can employ various communication technologies, including but not limited to WiFi, Bluetooth, Zigbee, Cellular (LTE, 5G), etc., to transmit data between various subsystems located at different layers efficiently.

End-users can interact with the IoT system 300 through the HI subsystem (e.g., output decision and data visualization, and inputs controls for human interaction). The HI subsystem may provide access to the individual subsystems and system level controls in the IoT system 300 for users to configure or enter inputs manually. User inputs/requests/commands received by the HI subsystem may be sent to the AI subsystem for processing via one or more AI machine learning models. Output decisions, NI interpretations, and data visualizations generated by the one or more AI machine learning models may be available for users at output terminals comprising the HI subsystem. Applications executing in the HI subsystem can leverage the output data from the AI subsystem to provide users with insights and help connect the IT system 300 with other IoT systems.

The NI and AI subsystems may be configured by a user for initial deployment of the IoT system 300. During operation of the IoT system 300, the AI and NI subsystems may reconfigure themselves based on feedback provided between the AI and NI subsystems. Iterative self-reconfiguration may allow the IoT system 300 to improve operation efficacy with minimal human intervention. The AI subsystem may comprise storage components that are configured to store data from the NI subsystem. The data storage system may support self-reconfiguring processes and enable the AI subsystem to be continuously trained without significant downtime. A user may configure the storage components to store raw data from the NI subsystem as well as processed data available at the AI subsystem. User access to data may be made available through the HI subsystem throughout various levels of abstraction, allowing for greater control over the IoT system 300.

According to various embodiments of the present disclosure, the IoT system 300 comprises an architecture that orchestrates seamless integration of NI and AI subsystems for ensuring reliable communication, efficient data processing, and effective decision-making within the IoT system 300.

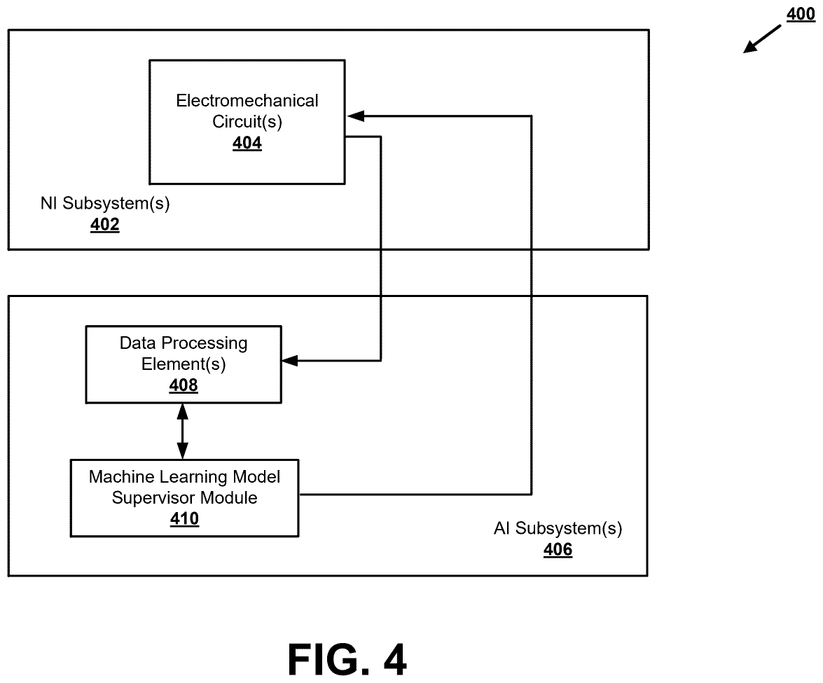

FIG. 4 depicts an architectural block diagram of an example FI system 400 in accordance with some embodiments discussed herein. The FI system 400 comprises one or more NI subsystems 402 and one or more AI subsystems 406. The one or more NI subsystems 402 comprise one or more electromechanical circuits 404. The one or more AI subsystems 406 comprise one or more data processing elements 408 and a machine learning model supervisor module 410.

### A. Example NI Subsystem

The one or more NI subsystems 402 may be configured to interface with the physical world by collecting data and interacting with the environment. The one or more NI subsystems 402 may interface with natural beings by using the one or more electromechanical circuits 404 which may comprise a suite of electromechanical sensors and actuators. Similar to deploying multiple sensors in a perception layer, multiple beings, for example, a swarm of bees, a colony of ants, or a pack of dogs, etc., may be deployed simultaneously. Natural beings may be selected for sensing stimuli based on the application and biological dependencies of selected species. One or more groups of selected species may be monitored with an associated array of sensors and actuators dedicated to observing the beings' responses. As such, stimulus-response pairs based on the selected natural beings may be associated as inputs and outputs of the one or more electromechanical circuits 404. A control unit associated with the one or more electromechanical circuits 404 in the one or more NI subsystems 402 may collect response data from sensors and transmit the data to the one or more AI subsystems 406 for processing. Natural beings that are interfaced with the one or more NI subsystems 402 may be trained and motivated autonomously with the one or more electromechanical circuits 404 to improve efficiency and allow the one or more NI subsystems 402 to adapt on the go for one or more applications.

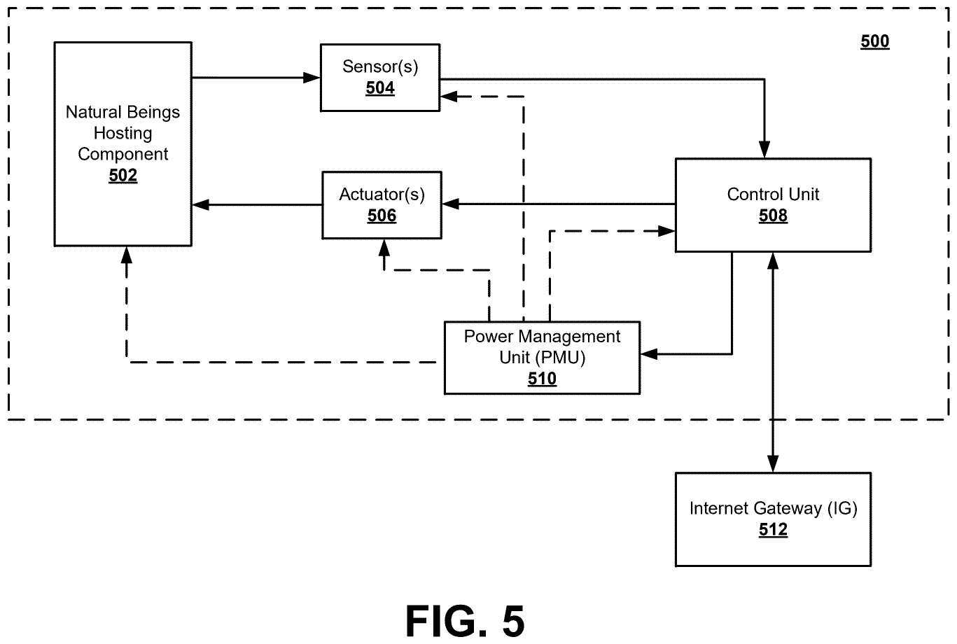

FIG. 5 depicts an architectural block diagram of an NI subsystem 500 in accordance with some embodiments discussed herein. The NI subsystem 500 is an example of the one or more NI subsystems 402 of FIG. 4. The NI subsystem 500 comprises a natural beings hosting component 502, one or more sensors 504, one or more actuators 506, a control unit 508, and a power management unit (PMU) 510.

The natural beings hosting component 502 may comprise a portion of the NI subsystem 500 responsible for maintaining living beings such as animals, insects, and plants. The beings may be deployed either individually or in a group, and multiple such individual beings or groups may be deployed simultaneously. For example, the NI subsystem 500 may employ natural beings in conjunction with the one or more sensors 504 and the one or more actuators 506 to measure and detect physical phenomena, such as temperature, air quality, water quality, scent/aromas, etc. Natural beings may have evolved sensory systems to detect physical phenomena and use their intelligence coupled with evolutionary instincts to interact with the physical world. The ability of natural beings to instinctively react to stimuli may enable the NI subsystem 500 to utilize the natural beings as extensions of the NI subsystem 500 that may respond, navigate, and engage with the physical world without reliance on complex electromechanical or processing systems.

Natural beings may be deployed in two modes-sensing and actuation. In some embodiments, sensing may comprise determining a response to a target physical phenomenon. A physical phenomenon may be introduced as stimulus (e.g., aromatic, environmental, biological) to selected natural beings, such as animals, birds, or insects. The beings' response to the phenomenon (stimuli) may be recorded via the one or more sensors 504 and sent to an AI subsystem by the control unit 508 to train a monitoring AI machine learning model. Once trained, the monitoring AI machine learning model may generate and provide an output to the control unit 508 in response to a change in physical phenomenon based on sensing data generated by the one or more sensors 504 with respect to the natural beings. In some embodiments, actuation may comprise the control unit 508 using a controlling AI machine learning model to generate instructions for performing user-specified tasks based on the output from the monitoring AI machine learning model. In some embodiments, the instructions may be provided by the AI subsystem to the one or more actuators 506 to intelligently direct and manage the activities (e.g., navigating, responding and engaging with stimuli) of the natural beings. For example, natural beings may be introduced to an environment in which they are motivated to perform an action or complete a certain task.

In some embodiments, the NI subsystem 500 may be configured to deploy natural beings in sensing and actuation modes simultaneously. In either mode, the natural beings may be allowed to act as actuators autonomously to a certain extent under the supervision of an AI subsystem. For example, a natural being deployed for sensing can autonomously navigate the environment to find a target source without specific instructions from an AI subsystem. Rather, the AI subsystem may govern the natural being as to how far it can interact with the environment.

The one or more sensors 504 and the one or more actuators 506 may be utilized in the NI subsystem 500 to capture the responses of natural beings and to manage the activity of the beings as per user requirements, respectively. The one or more sensors 504 may comprise devices, such as but not limited to, infrared cameras, or wide-frequency-range tuned microphones, may be utilized to record responses of natural beings to stimuli. Sensor devices may be selected based on physical characteristics of responses generated by the natural beings. For example, a change in color or movement can be identified by using a camera and sounds made by beings outside an auditory range in response to a stimulus may be detected by using a specialized microphone.

The one or more actuators 506 may comprises devices, such as a speaker, light-emitting diodes (LEDs), olfactory synthesizers, or food dispensers. In some embodiments, the one or more actuators 506 may be configured to assist the control unit 508 to implement instructions generated by an AI subsystem or as specified by a user. Mechanisms may be used to tame natural beings, such as treats that can be set up to train and motivate natural beings to perform specified tasks. Training and motivation processes may be automated with AI learning from behavior data received from the NI subsystem 500 and governing the NI subsystem 500 through sensors and actuators.

In some embodiments, the control unit 508 may be configured to convert data associated with actions in the NI subsystem 500 to digital data for processing by an AI subsystem and convert digital instructions generated by the AI subsystem to actions to be performed with the NI subsystem 500. The control unit 508 may comprise a microcontroller configured to run programmed processes that manage signal processing, utilization of natural beings, and enables the control unit 508 to act as an interface between the digital and the physical world. In some embodiments, edge devices can be positioned directly in the control unit 508, interfacing the edge devices with the microcontroller via communication ports (e.g., inter-integrated circuit (I2C), or serial peripheral interface (SPI)).

In some embodiments, the control unit 508 may receive raw data from sensors. The control unit 508 can interface with digital sensors via protocols including but not limited to I2C, SPI, or Universal Asynchronous Receiver-Transmitter (UART), and analog sensors through analog to digital converter (ADC) and digital to analog converter (DAC). The control unit 508 may further comprise an onboard signal processor configured to perform mathematical operations to process the raw data. The microcontroller may then package the data processed by the onboard signal processor in a given format to transmit via an IG 512. The microcontroller may transmit the data over a connected network using a network interface in the control unit 508. Similarly, instructions from an AI subsystem may be transmitted to the control unit 508 over the network. The microcontroller may process the instructions to generate signals that are then given to actuators in the NI subsystem 500. The actuators may be configured to operate based on input signals from the control unit 508 to govern natural beings and to perform planned tasks.

The PMU 510 may be configured to supply required energy to components in the NI subsystem 500. For example, the NI subsystem 500 may be deployed in the field, without a constant source of power or an electric outlet. In such scenarios, batteries may be utilized, and the PMU 510 may be responsible for monitoring the batteries and regulating the power from the batteries. The PMU 510 may be configured to supply power to components, such as sensors, actuators, microcontrollers, and other supporting electromechanical circuits in the NI subsystem 500 with specific voltages and current ratings are required. The PMU 510 may also be configured to disperse food to the natural beings. In some embodiments, a microcontroller in a control unit 508 may translate instructions from an AI subsystem, such as food delivery instructions, and transmit the instructions to the PMU 510. Based on the instructions from the AI subsystem, the PMU 510 may release food as directed in the instructions with the help of dedicated actuators for food delivery. As such, the food delivery process may be automated.

### B. AI Subsystem

Referring back to FIG. 4, the one or more AI subsystems 406 may be configured as a processing node for data originating from the one or more NI subsystems 402. Data from the one or more NI subsystems 402 may include but is not limited to data associated with activity and behavioral information of the natural beings, or sensor data from connected edge devices. Data received by the one or more AI subsystems 406 may be processed and used for training AI machine learning models. In some embodiments, the one or more AI subsystems 406 may be hosted on in a cloud computing platform to employ computing resources for training and deploying AI machine learning models. The trained AI machine learning models may be trained to make intelligent predictions and generate instructions for initiating the performance of prediction-based actions. For example, the trained AI machine learning models may be deployed to interpret, control and adapt the one or more NI subsystems 402 to leverage its on-board actuators and perform actions based on real-time data. As such, the trained AI machine learning models may allow an FI system to be flexible and self-reconfigurable to better suite the user requirements. In some embodiments, the one or more AI subsystems 406 comprises two AI machine learning models, each dedicated to monitoring or controlling the one or more NI subsystems 402, respectively. Other AI machine learning models may be deployed with the one or more AI subsystems 406 in addition to the two models.

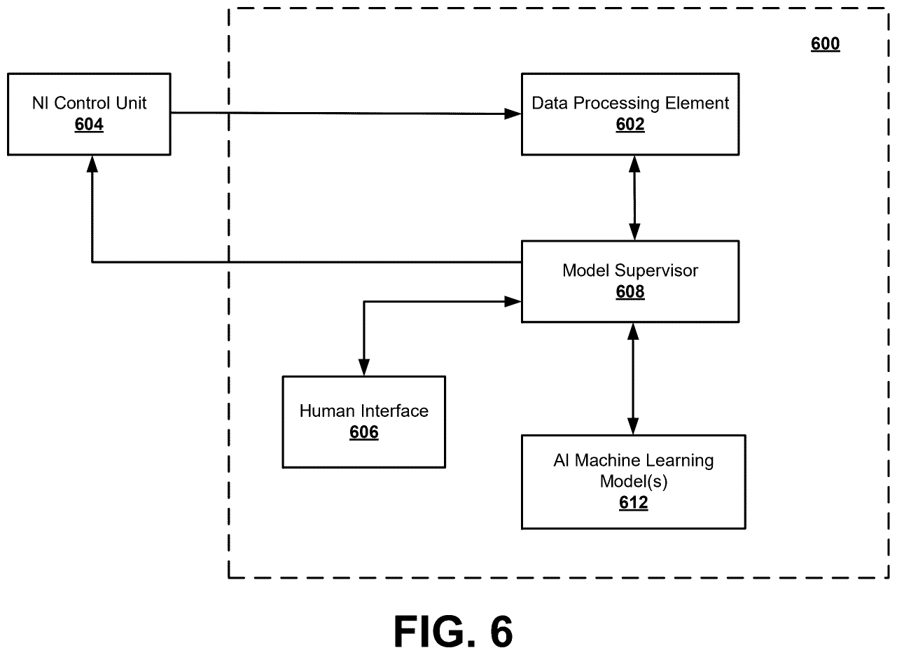

FIG. 6 depicts an architectural block diagram of an example AI subsystem 600 in accordance with some embodiments discussed herein. The AI subsystem 600 is an example of the one or more AI subsystems 406 of FIG. 4. The AI subsystem 600 comprises a data processing element 602, a human interface 606, a model supervisor 608, and one or more AI machine learning models 612.

The data processing element 602 comprises a data collection module, a data transformation module, and a feature extraction module. Digital data from the NI subsystem may be gathered and stored by the data collection module. An NI control unit 604 (e.g., control unit 508) may be configured to generate the digital data which may include, but not be limited to, information regarding the activity and behavior of an NI subsystem (e.g., one or more NI subsystems 402 or NI subsystem 500). The digital data may comprise multi-dimensional vector data that may be formatted by the control unit in a format suitable for transmission through a network, e.g., via an IG. Data gathered and stored by the data collection module may be transmitted to the data transformation module. The data transformation module may perform operations on the data from data collection module, such as cleaning, scaling, and/or normalization. Cleaning the data may comprise identifying and handling any missing, inconsistent, or erroneous values. Missing data can be filled through imputation techniques, while inconsistent values can be corrected or removed. Cleaning the data may ensure that the one or more AI machine learning models 612 are trained on reliable and complete datasets. Normalizing and scaling the data may ensure that all features within training datasets are on a similar scale, thus preventing certain features from dominating the training process due to their larger magnitude or frequent occurrence.

Data processed by the data transformation module may be transmitted to the feature extraction module for performing aggregation, feature engineering, and/or data splitting processes. Feature engineering may comprise selecting and creating relevant features from raw data that are likely to improve an AI machine learning model's performance. For example, the data transformation module may create new features based on domain knowledge or extracting meaningful patterns from existing data received from an NI subsystem. Before training the one or more AI machine learning models 612, training data may be split into training and testing sets. The training set may be used to train the one or more AI machine learning models 612, while the testing set may be used to evaluate its performance. Splitting the training data into training and testing sets may help assess how well the one or more AI machine learning models 612 generalize to new, unseen data.

The model supervisor 608 may be configured to train and deploy the one or more AI machine learning models 612. In some embodiments, the model supervisor 608 allows the automation of iterative training and deploying of the one or more AI machine learning models 612 which makes an FI system autonomous. The model supervisor 608 may comprise a processing unit and a discriminator. Users may provide input via the human interface 606 to modify, instruct, or add supporting elements, such as additional memory/computing resources to the model supervisor 608, further improving functionality of the model supervisor 608. AI algorithms and models may be selected for the 600 based on IoT application (e.g., based on input requests from the human interface 606) and a type of task natural beings associated with an NI subsystem are to perform. For example, classification machine learning models may be employed for categorical outcomes, such as for monitoring whether a natural being is exhibiting a specific type of response. Similarly, regression machine learning models may be used for predicting continuous values and used as a basis for generating end-goal oriented instructions to an NI subsystem.

In some embodiments, the discriminator may be configured to provide continuous feedback to a supervisor processing unit. In some embodiments, trained ones of the one or more AI machine learning models 612 are evaluated on a testing set by the model supervisor 608 to assess performance. Evaluation metrics such as accuracy, precision, recall, or mean squared error may be used to measure how well an AI machine learning model performs on unseen data. Based on feedback, data from NI and user parameters, the one or more AI machine learning models 612 may be iteratively improved. In some embodiments, if necessary, the model supervisor 608 may fine-tune the one or more AI machine learning models 612 or optimize hyperparameters of the one or more AI machine learning models 612 to achieve better results. Trained ones of the one or more AI machine learning models 612 may be deployed to manage and control an FI system by integration into the AI subsystem 600, which can be hosted at the field (e.g., a computing entity or device) or in a cloud platform depending on a specific IoT architecture. The one or more AI machine learning models 612 may receive real-time data from sensors and actuators of an NI subsystem, make predictions or decisions, and send control instructions to the NI subsystem where natural beings can act as, or in conjunction with, actuators to perform desired actions.

In some embodiments, the AI subsystem 600 may be configured to host the one or more AI machine learning models 612 to train and deploy in parallel. In some embodiments, the one or more AI machine learning models 612 may comprise a monitoring AI machine learning model and a controlling AI machine learning model that are configured to interpret or control natural beings interfaced with an NI subsystem, respectively. A monitoring AI machine learning model may be trained and deployed to identify actions of natural beings interfaced with an NI subsystem and associate the actions to a unit change of a quantized physical parameter associated with a target stimulus. The monitoring AI machine learning model may monitor and interpret NI subsystem activity and provides insights of NI subsystem behavior. A controlling AI machine learning model may be trained with output from the monitoring AI machine learning model along with data from an NI subsystem to understand the behavior of the NI subsystem and generate instructions to control actions of natural beings interfaced with the NI subsystem. As such, a combination of the monitoring AI machine learning model and the controlling AI machine learning model may allow the AI subsystem 600 to function and improve autonomously while accommodating user inputs to perform desired actions. In some embodiments, output and/or interpretations generated by the one or more AI machine learning models 612 may be provided as data visualizations via the human interface 606.

According to various embodiments of the present disclosure, functionality of an FI system may vary based on a manner in which an AI subsystem is configured with an NI subsystem. For example, one or more AI subsystems and one or more NI subsystems may be coupled in one of a plurality of configurations or in various configurations simultaneously. In some embodiments, an AI subsystem may be coupled to an NI subsystem in any one of (i) One-to-One (“1×1,”) (ii) M-to-One (“M×1,”) (iii) One-to-N (“1×N,”) or (iv) M-to-N (“M×N”) configurations. M may represent a number of AI subsystems and N may represent a number of NI subsystems. The AI and NI subsystems may be communicatively coupled to each other through an IG transferring data to and from the AI and NI subsystems.

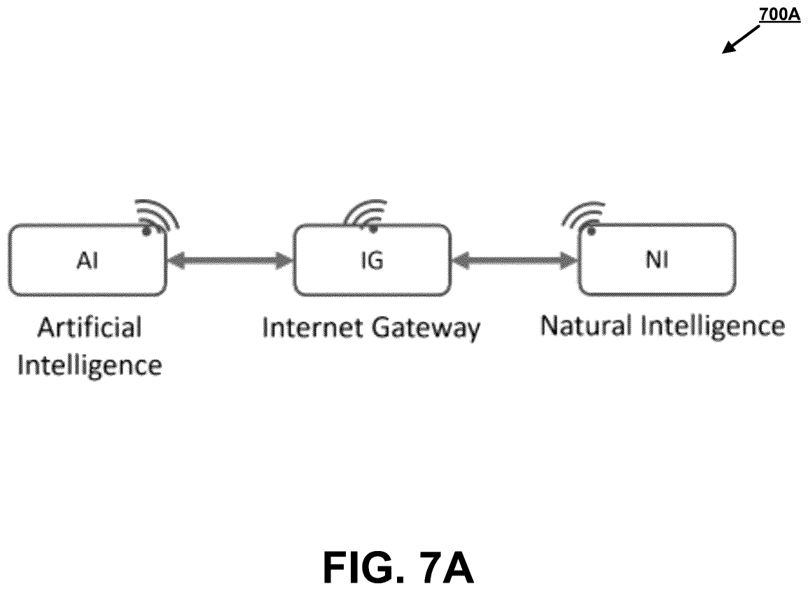

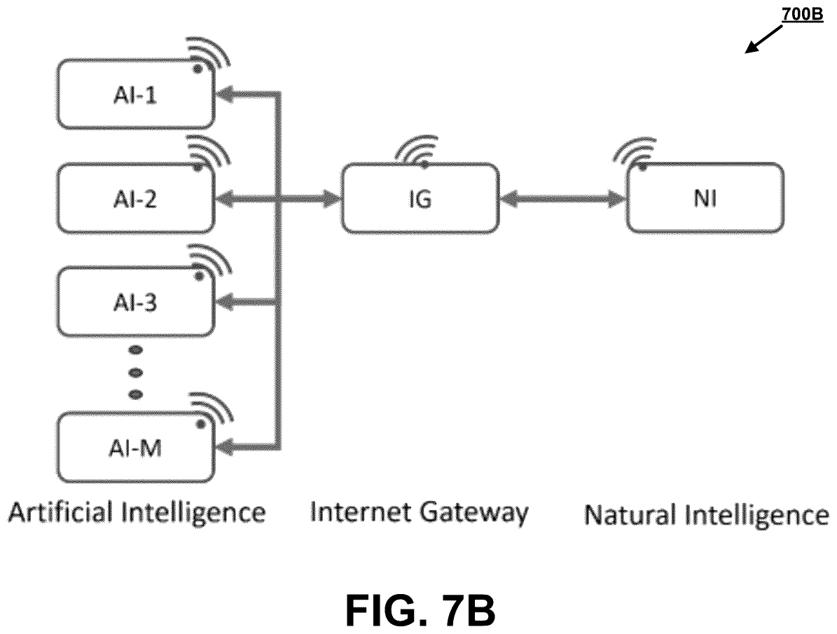

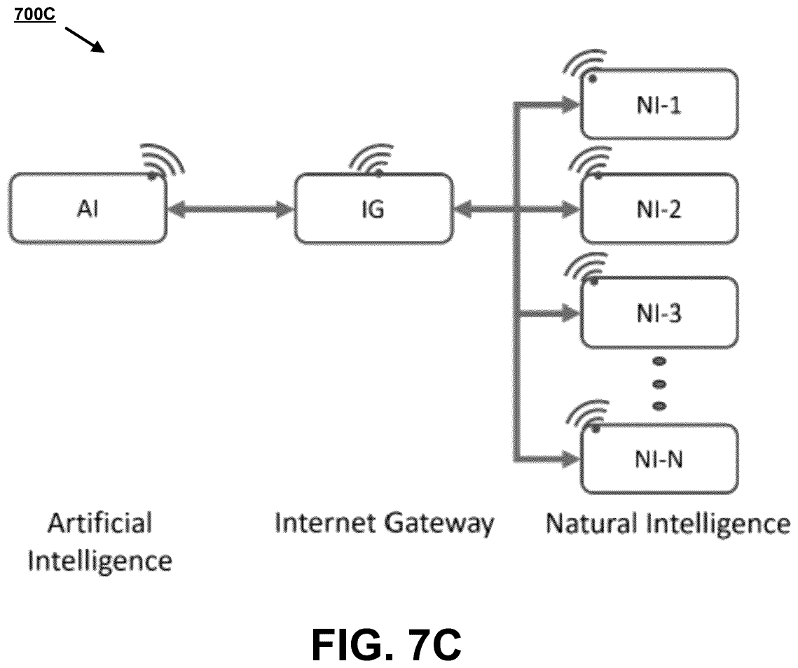

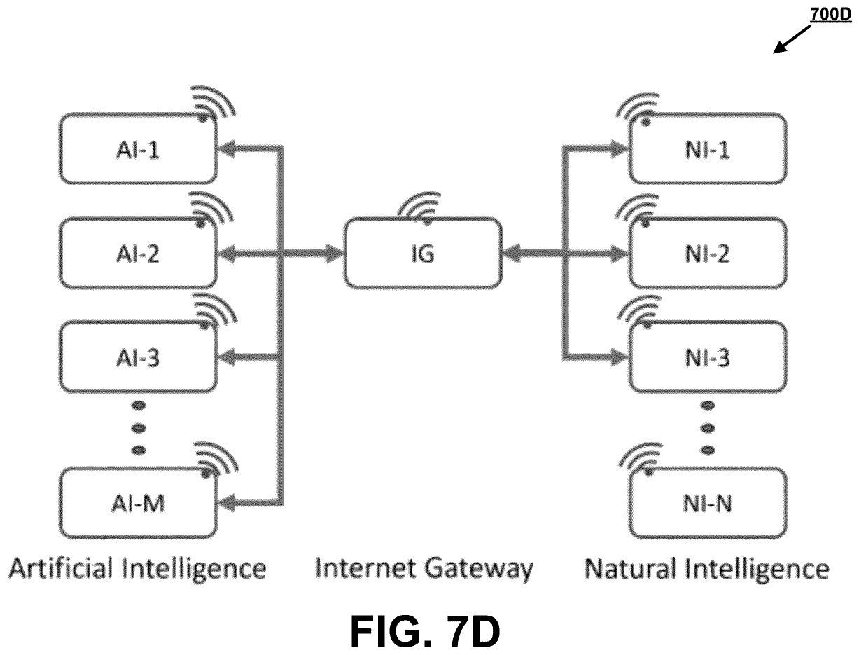

FIG. 7A is a diagram of an example FI system 700A in accordance with some embodiments of the present disclosure. The FI system 700A comprises a single AI subsystem that is communicatively coupled to a single NI subsystem in a 1×1 configuration.

FIG. 7B is a diagram of an example FI system 700B in accordance with some embodiments of the present disclosure. The FI system 700B comprises M AI subsystems that are communicatively coupled to a single NI subsystem in a M×1 configuration. The M number of AI subsystems may also be communicatively coupled to each other and share knowledge based on data provided by the NI subsystem. Although the M AI subsystems may access the NI subsystem through an IG, the M AI subsystems may also communicate with each other without IG. In some embodiments where the AI subsystems may not share a common host platform, the AI subsystems may utilize IG resources to transfer knowledge among any of the AI subsystems.

FIG. 7C is a diagram of an example FI system 700C in accordance with some embodiments of the present disclosure. The FI system 700C comprises a single AI subsystem that is communicatively coupled to N number of NI subsystems in a 1×N configuration. The single AI subsystem may communicate and coordinate instructions with N number of NI subsystems. The AI subsystem may also help manage resources between the NI subsystems coupled to the AI subsystem. The NI subsystems in the 1×N configuration may be interconnected and share a sensor suite without an IG unless deployed outside of an operational range. The AI subsystem may assist in distributing resources based on requirement.

FIG. 7D is a diagram of an example FI system 700D in accordance with some embodiments of the present disclosure. The FI system 700D comprises M number of AI subsystems that are communicatively coupled to N number of NI subsystems in an M×N configuration. In some embodiments, the M×N configuration may comprise an ad-hoc configuration. In some embodiments, the M number of AI subsystems and the N number of NI subsystems may be interconnected and share resources according to demand. In some embodiments, the M×N configuration may comprise a subset of “1×1,” “M×1,” or “1×N” configurations simultaneously coexisting. An IG may provide connectivity between the NI and AI subsystems in any one of a plurality of configurations within the M×N configuration.

In some embodiments, an FI system comprising a plurality of AI and NI subsystems working together may prioritize a leader/chain of command in facilitating organized flow of data. According to various embodiments of the present disclosure, an FI system may comprise any of AI monitoring NI, AI controlling NI, or NI running independently states of configuration to simplify the assignment of control over the different systems.

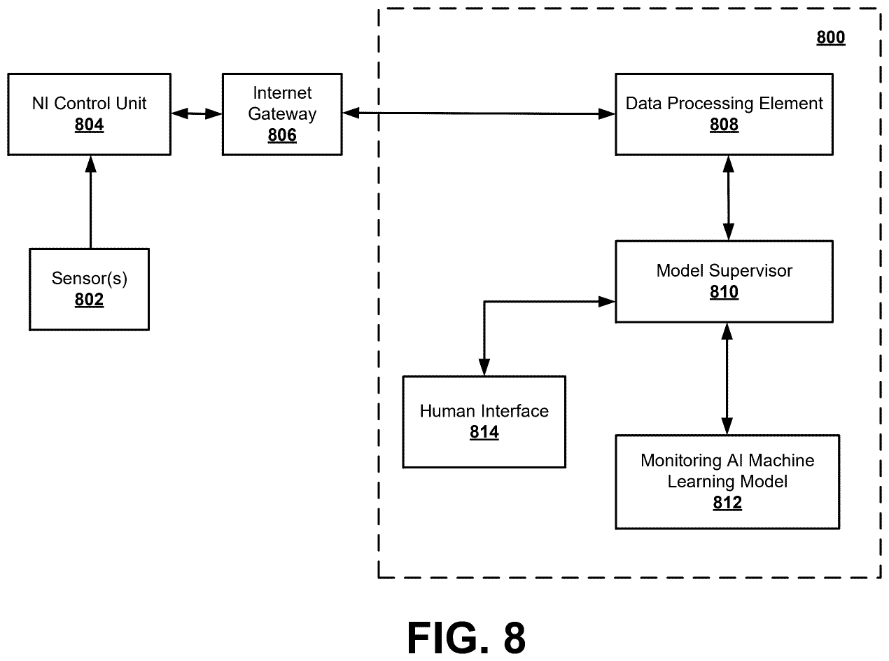

FIG. 8 depicts an architectural block diagram of an example AI subsystem 800 in an AI monitoring NI configuration in accordance with some embodiments discussed herein. The AI subsystem 800 comprises a data processing element 808, a model supervisor 810, a monitoring AI machine learning model 812, and a human interface 814.

An NI subsystem may be configured to train the AI subsystem 800. In some embodiments, an NI control unit 804 of an NI subsystem may provide data to the AI subsystem 800 via an IG 806, which may be processed (e.g., data collection, data transformation, and/or feature extraction) by the data processing element 808 and used by the model supervisor 810 to train and validate the monitoring AI machine learning model 812. The AI subsystem 800 may be suitable when an NI subsystem is deployed for sensing. In some embodiments, the AI monitoring NI configuration depicted in FIG. 8 may be synonymous to an AI subsystem acting as a slave while an NI subsystem acts as the master.

In some embodiments, the model supervisor 810 may be further configured to monitor the monitoring AI machine learning model 812. The model supervisor 810 may comprise a discriminator and a supervisor processing unit where the discriminator may provide continuous feedback to the supervisor processing unit based on data from the NI control unit 804 and user parameters via human interface 814. As such, the supervisor processing unit may iteratively update (e.g., fine-tune and/or modify parameters or weights) and improve the monitoring AI machine learning model 812 based on the feedback. In some embodiments, the monitoring AI machine learning model 812 may be trained to monitor and provide an estimated meaningful observation of activity/behavior data generated by NI control unit 804. For example, the NI control unit 804 may generate activity data based on responses of natural beings in response to target stimuli that is captured by one or more sensors 802. The human interface 814 may provide user input (modifications/instruction to the AI system from users) and data visualization (e.g., output decisions and interpretations of NI activity for human interaction).

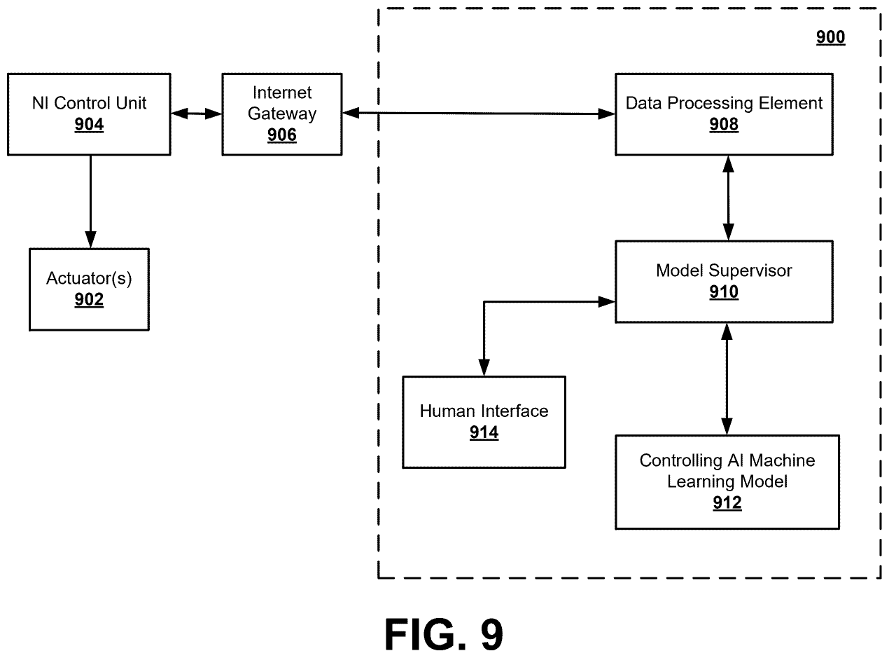

FIG. 9 depicts an architectural block diagram of an example AI subsystem 900 in an AI controlling NI configuration in accordance with some embodiments discussed herein. The AI subsystem 900 comprises a data processing element 908, a model supervisor 910, a controlling AI machine learning model 912, and a human interface 914.

The AI subsystem 900 may take the role of controlling an NI subsystem. In some embodiments, the controlling AI machine learning model 912 may be trained by the model supervisor 910 (e.g., with output from the monitoring AI machine learning model 812 and data from the NI subsystem) and used to generate instructions for controlling actions of natural beings based on user inputs or commands via the human interface 914. In some embodiments, user inputs or commands received from the human interface 914 may be provided to the data processing element 908 for processing (e.g., data collection, data transformation, and/or feature extraction) prior to inputting to the controlling AI machine learning model 912 by the model supervisor 910. The controlling AI machine learning model 912 may generate instructions based on the user inputs or commands and provide the instructions to an NI control unit 904 of an NI subsystem via IG 906. As depicted in FIG. 9, the NI control unit 904 is coupled to one or more actuators 902. In some embodiments, the AI subsystem 900 may provide instructions or requests from the controlling AI machine learning model 912 to the NI control unit 904 for instructing how natural beings should act out their responsibilities. The control unit may modify behavior of natural beings by configuring the one or more actuators 902 to manage the behavior and/or activities of the natural beings based on the instructions from the AI subsystem 900.

In some embodiments, the model supervisor 910 may be configured to monitor the controlling AI machine learning model 912. The model supervisor 910 may comprise a discriminator and a supervisor processing unit where the discriminator may provide continuous feedback to the supervisor processing unit based on data from the NI control unit 904 and user parameters via the human interface 914. As such, the supervisor processing unit may iteratively update (e.g., fine-tune and/or modify parameters or weights) and improve the controlling AI machine learning model 912 based on the feedback. In some embodiments, the AI controlling NI configuration depicted in FIG. 9 may be synonymous to an AI subsystem acting as the master while an NI subsystem acts as a slave.

According to some embodiments, in scenarios where AI capabilities are not required, an NI subsystem may be deployed independently. A control unit of an NI subsystem may be configured to take the role of an AI subsystem.

The aforementioned configurations may exist simultaneously in one or more modes of connectivity. In some embodiments, AI monitoring NI and AI controlling NI configurations may exist in 1×1 configurations where an AI subsystem may comprise two individual models for each configuration. In some embodiments, after an initial configuration, any configuration of AI monitoring NI or AI controlling NI configurations is capable of allowing FI to function autonomously via closed-loop feedback between both AI and NI subsystems. Multiple configurations of FI may be possible simultaneously in M×N, 1×N, M×1 connections as well.

### Example System Operations

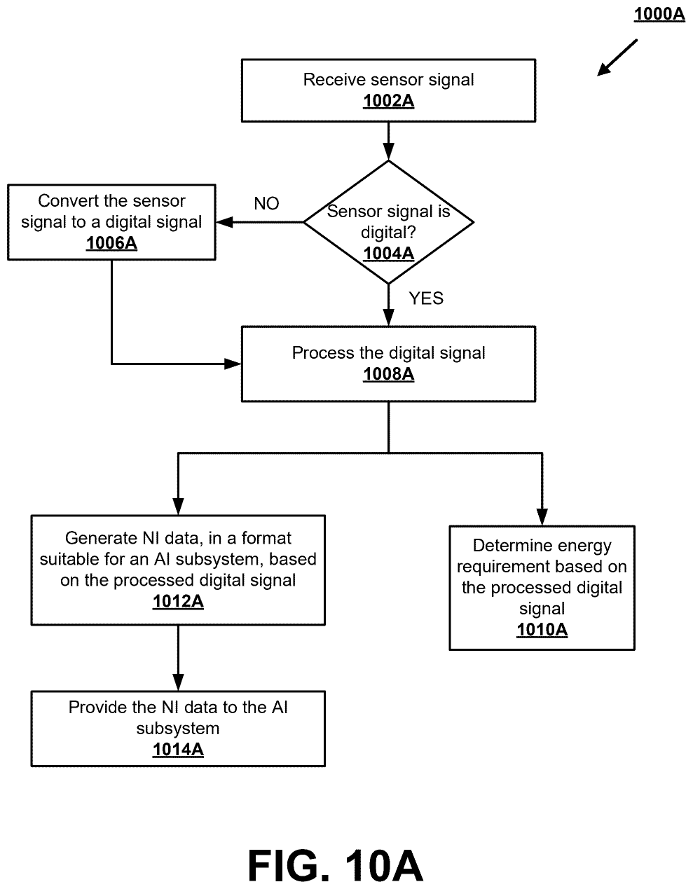

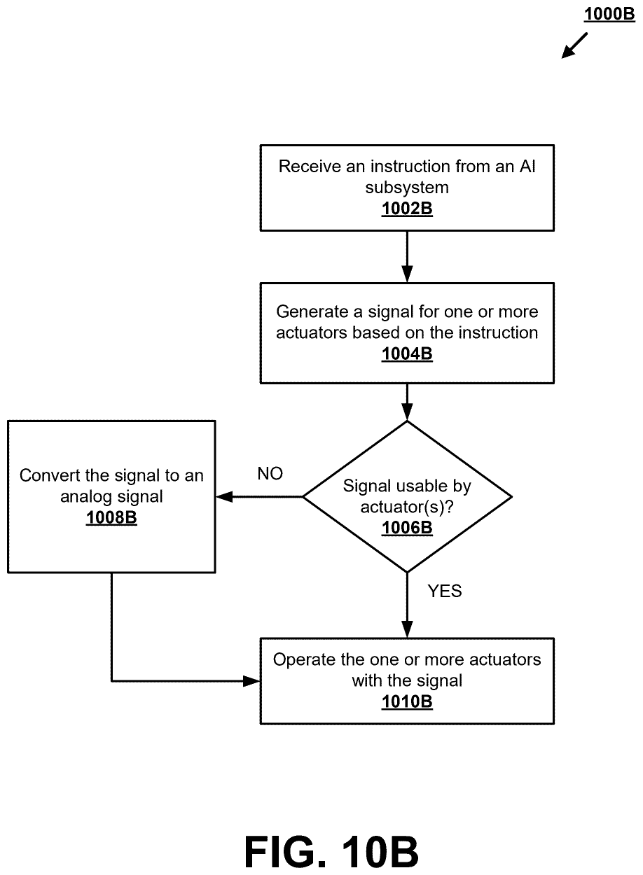

FIG. 10A depicts an example process 1000A for processing sensor data in accordance with some embodiments discussed herein.

In some embodiments, the process 1000A begins at step/operation 1002A when one or more processors comprising a control unit receives a sensor signal. The sensor signal may be generated by one or more sensors that are configured to monitor natural beings. For example, natural beings exposed to stimuli may respond to the stimuli in a manner that may be detected by the one or more sensors. The one or more sensors may convert responses of the natural beings to electrical signals that may be provided to the control unit.

In some embodiments, at step/operation 1004A, the one or more processors determine whether the sensor signal (e.g., in its raw form) is a digital signal.

In some embodiments, if the sensor signal is not digital, at step/operation 1006A, the one or more processors convert the sensor signal to a digital signal.

In some embodiments, at step/operation 1008A, the one or more processors process the digital signal. For example, the one or more processors may perform mathematical operations to process the digital signal and/or convert the digital signal into digital data.

In some embodiments, at step/operation 1010A, the one or more processors determine an energy requirement associated with the natural beings based on the processed digital signal.

The one or more processors may deliver food to the natural beings based on the energy requirement.

In some embodiments, at step/operation 1012A, the one or more processors generate NI data, in a format suitable for an AI subsystem, based on the processed digital signal. In some embodiments, the NI data may comprise multidimensional vector data. In some embodiments, the NI data comprises a data format that is suitable for transmission over a network.

In some embodiments, at step/operation 1014A, the one or more processors provide the NI data to the AI subsystem. The one or more processors may be coupled to a network interface that is configured to connect to an available network and send the NI data to the AI subsystem.

FIG. 10B depicts an example process 1000B for processing actuator instructions in accordance with some embodiments discussed herein.

In some embodiments, the process 1000B begins at step/operation 1002B when one or more processors comprising a control unit receives an instruction from an AI subsystem. The instruction from the AI subsystem may be received by a control unit through a connected network. The input instructions may comprise instructions generated by an AI machine learning model (e.g., a controlling AI machine learning model) for controlling the behavior of natural beings by configuring one or more actuators to manage the natural beings and their activities.

In some embodiments, at step/operation 1004B, the one or more processors generate a signal for one or more actuators based on the instruction. The instruction may be processed by the one or more processors to generate a signal that is associated with one or more functions (e.g., manage, motivate, or train behavior of natural beings) that may be performed via the one or more actuators. In some embodiments, the signal generated for the one or more actuators comprises a digital signal.

In some embodiments, at step/operation 1006B, the one or more processors determine whether the signal is usable by the one or more actuators. For a given actuator receiving the generated signal, a determination may be made whether the actuator may use the (digital) signal. If the given actuator is able to use the signal, the actuator may operate based on the generated signal.

In some embodiments, if the signal is not usable by the one or more actuators, at step/operation 1008B, the one or more processors convert the signal (from a digital signal) to an analog signal.

In some embodiments, at step/operation 1010B, the one or more processors operate the one or more actuators with the signal (or the analog signal if the signal is not usable by the one or more actuators). Accordingly, behavior of the natural beings may be controlled based on the operation of the one or more actuators.

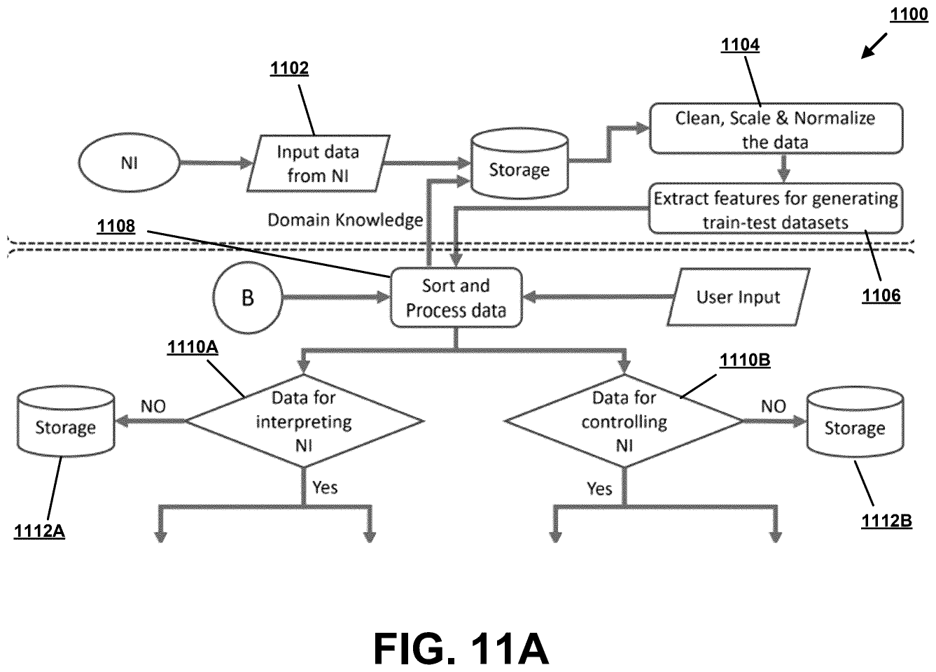

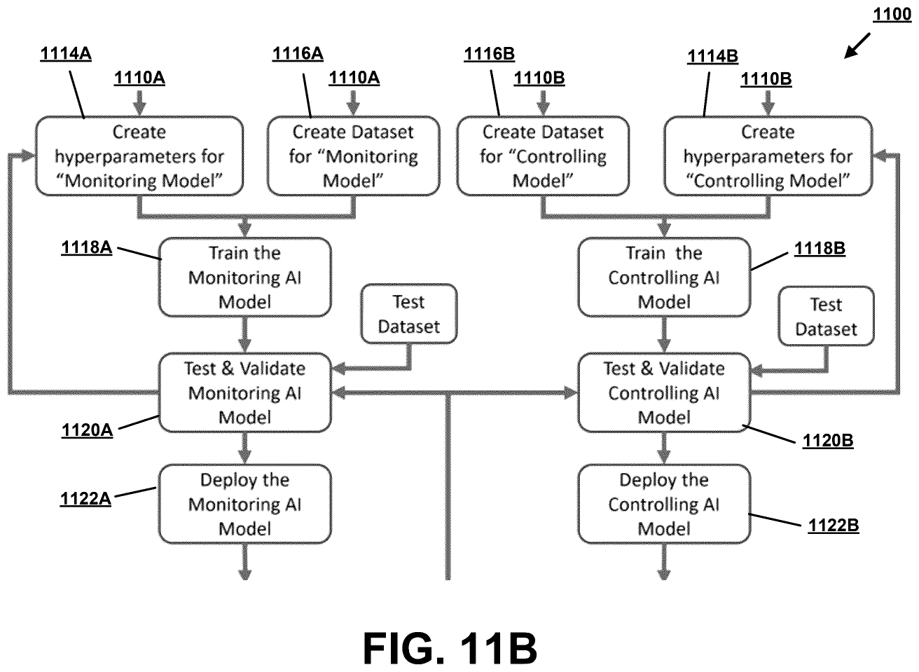

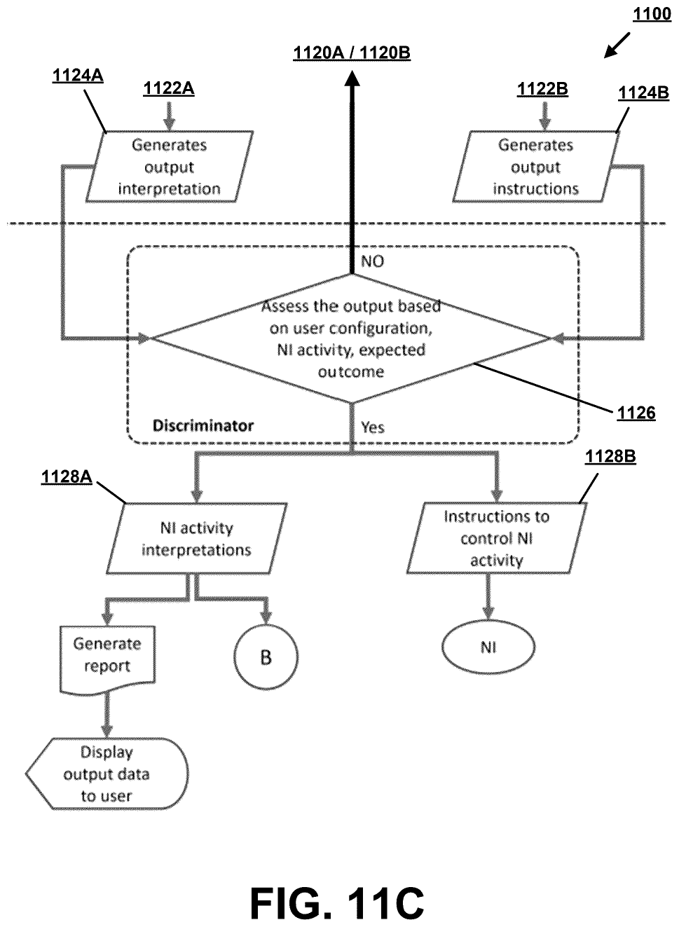

FIG. 11A, 11B, 11C illustrate a flow chart of an example process 1100 performed by an AI subsystem in accordance with some embodiments discussed herein. According to various embodiments of the present disclosure, an AI subsystem may be hosted on a cloud computing platform or a computing entity, such as a computer, server, the like, and/or any combination of devices or entities adapted to perform the functions, operations, and/or processes described herein.

Referring to FIG. 11A, in some embodiments, the process 1100 begins at step/operation 1102 when one or more processors executing an AI subsystem, receives input data from an NI subsystem. The input data may be saved into storage (e.g., non-transitory computer readable media, such as non-volatile media (also referred to as non-volatile storage, memory, memory storage, memory circuitry, and/or similar terms used herein interchangeably)).

In some embodiments, at step/operation 1104, the one or more processors process (cleans, scales, and normalizes) the saved data.

In some embodiments, at step/operation 1106, the one or more processors extract features for generating training-test datasets based on the processed data.

In some embodiments, at step/operation 1108, the one or more processors sort and further process the extracted features based on user input for classifying the extracted features as features for monitoring an NI subsystem or controlling an NI subsystem.

In some embodiments, at steps/operations 1110A and 1110B, the one or more processors determine whether the extracted features are associated with interpreting NI or controlling NI, respectively.

In some embodiments, if the extracted features comprise that are not associated with either interpreting NI or controlling NI, at steps/operations 1112A and 1112B, the one or more processors store the extracted features in a repository.

Referring to FIG. 11B, in some embodiments, at step/operation 1114A, the one or more processors create hyperparameters for training a monitoring AI machine learning model. Similarly, in some embodiments, at step/operation 1114B, the one or more processors create hyperparameters for training a controlling AI machine learning model.

In some embodiments, at steps/operations 1116A and 1116B, the one or more processors create training datasets for training the monitoring AI machine learning model and the controlling AI machine learning model, respectively.

In some embodiments, at steps/operations 1118A and 1118B, the one or more processors train the monitoring AI machine learning model and the controlling AI machine learning model based on the hyperparameters and the training datasets, respectively.

In some embodiments, at steps/operations 1120A and 1120B, the one or more processors test and validate the monitoring AI machine learning model and the controlling AI machine learning model based on the test datasets, respectively.

In some embodiments, at steps/operations 1122A and 1122B, the one or more processors deploy the monitoring AI machine learning model and the controlling AI machine learning model.

Referring to FIG. 11C, at steps/operations 1124A and 1124B, the one or more processors, using the deployed models, generate output that are provided to a discriminator.

In some embodiments, at step/operation 1126, the one or more processors, using the discriminator, assess the output of the monitoring AI machine learning model or the controlling AI machine learning model by comparing the output with one or more of user configurations, NI subsystem activities, or expected outcomes.

In some embodiments, at step/operation 1128A, the one or more processors generate NI activity interpretations based on the assessment of the output. The comparison is used as feedback (“B”) by the one or more processors to iteratively adjust/optimize the training-test datasets and hyperparameters for training of the monitoring AI machine learning model or the controlling AI machine learning model and generate final results as a report that may be displayed to a user. In some embodiments, the one or more processors may use the output from a monitoring AI machine learning model to add domain knowledge of the application which may be used as inputs to train a controlling AI machine learning model.

In some embodiments, at step/operation 1128B, the one or more processors generate instructions to control NI activity based on the assessment of the output.

Various embodiments of the present disclosure describe steps, operations, processes, methods, functions, and/or the like for training AI machine learning models to manage and control natural beings interfaced with one or more NI subsystems. The natural beings may provide sensor and/or actuator functionality and can be used in numerous real-world use cases across various industries. Some use cases include:
1) enhancing and optimizing pollination by natural pollinators, such as bees in a selected field/area.
2) detecting gas concentration, identifying the source of gas leakage, and identifying the gas type.
3) detection of invasive species in shipping containers.
4) non-intrusive detection of illegal substances in mail packages.
5) detection of pests in farmland and suppression of pests using natural predators-organic pest control.
6) detection of water quality and identifying the source of pollution.
7) detecting objects or animals at low light conditions-night vision.
8) automated assistive farming with bees. FI can help with monitoring the health of bees, improving pollination, and crossbreeding of selected crops. FI can control the bees' behavior and navigation using light and sound cues.
9) catalyzing the carbon dioxide (CO2) absorption of rocks with the help of ants.
10) detection of earthquake and estimating the magnitude of the quake.
11) identification and delivery of the payload to hard-to-reach spots.
12) using insects for structural health monitoring in buildings.
13) utilizing insects to estimate and improve soil quality.
14) non-invasive and inexpensive detection and screening of cancer in its early stages with the help of dogs or ants to prevent the growth of cancer.
15) detecting and identifying the location of explosives with the help of bees.

Designing an IoT system that collects data from NI, trains AI machine learning models, and deploys the AI machine learning models to manage/control the IoT system may require careful consideration of various components and their integration.

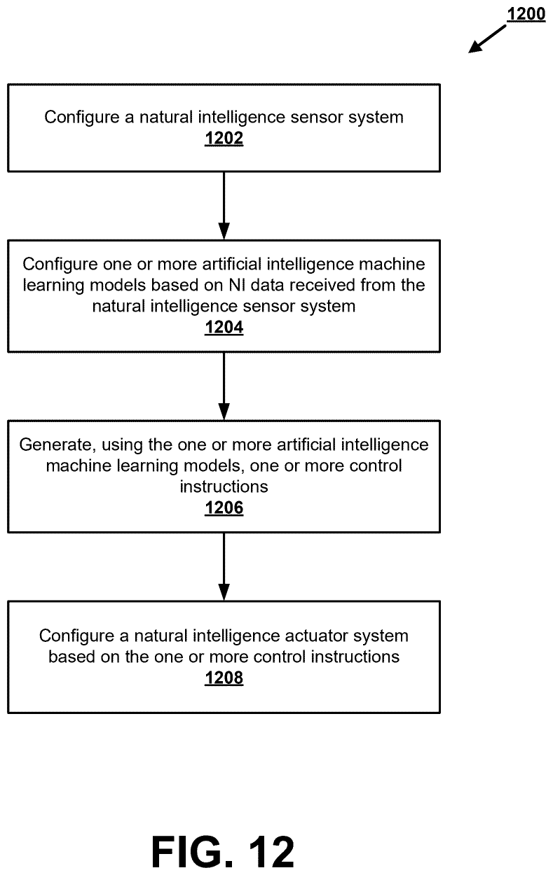

FIG. 12 depicts an example process 1200 for configuring an FI system in accordance with some embodiments discussed herein.

In some embodiments, via the various steps/operations of the process 1200, a computing entity may use one or more AI machine learning models to monitor and control NI functionalities of an FI system.

In some embodiments, the process 1200 begins at step/operation 1202 when a computing entity configures an NI sensor system. In some embodiments, configuring the NI sensor system may comprise receiving a problem statement that is defined and provided by a user. A problem statement may be associated with a specific IoT application. For example, a purpose and functionality of an FI system may be specified. In some embodiments, a corresponding physical phenomenon may be identified for a selected application. A physical phenomenon may be associated with characteristics (e.g., aromatic, chemical, physical, etc.) that is to be detected using the NI sensor system. A physical phenomenon may include but is not limited to temperature, gas concentration, or humidity, in an environment to be measured/monitored/controlled.

In some embodiments, the problem statement may also be used to determine a selection of natural beings that are well-suited for specific objectives and environmental conditions. That is, natural beings may be selected for responding to stimuli in a tangible way. For example, a change in physical phenomenon may be associated with a corresponding response from a natural being. As such, a set of stimulus-response pairs for specific natural beings may be selected to function as sensors to be employed in the NI sensor system.

Table 2 lists an example set of stimulus-response pairs for a few insects (i.e., natural beings) that can be selected to act as, or in conjunction with, sensors to be employed in the NI sensor system. Any kind of natural beings and their responses may be selected.

TABLE 2

| Insects | Sensing/Stimuli | Response | Reason |
|---|---|---|---|
| Stoneflies | Water pollution | Jumps away from | Stone flies do pushups or jump |
| | | stimulus | away to move more water across |
| | | | gills when oxygen levels decrease. |
| Honeybees | Scent/taste | Movement towards or | When unheated and heated feeders |
| | | away from source | contain same sucrose concentration, |
| | | | bees select the unheated one. But |
| | | | when sucrose concentration is |
| | | | reduced in unheated feeder, bees |
| | | | select heated feeder. |
| | Electric field | | Bumblebees tend to select flowers |
| | | | with nectar based on the electric |
| | | | field around the flower. |
| House | Scent | Movement towards | House flies tend to fly in rectangles, |
| | | source | goes straight and takes a sharp 90- |
| | | | degree change in direction. It uses |
| | | | this type of movement to locate the |
| | | | source of scent. |
| Flies | Weather, sunlight | Change in flight | Flight behavior, activity and |
| | (time of day) | pattern | directionality changes as they try to |
| | | | navigate in the changed |
| | | | environment. |
| Ants | Earthquake | Coming out of the | Ants stop going into the mound. |
| | | Ant mound | They gather in groups outside |
| | | | before, during and for almost a day |
| | | | after the quake. |
| | Scent/temperature | Movement towards | Ants tend to form groups and gather |
| | | the target | around the source. |
| Roach | Scent | Movement towards | Roaches create scented trails to |
| | | target | navigate between known food |
| | | | sources. |
| | Light | Movement away from | Roaches run away trying to hide |
| | | source | from a predator. |

In some embodiments, configuring the NI sensor system may further comprise configuring one or more sensors to read responses of the natural beings. In some embodiments, the one or more sensors may be selected based on responses of natural beings to specific physical phenomena thereby ensuring a robust AI-NI feedback loop. For example, specific types of sensors may be suitable for identifying/reading specific responses generated by specific natural beings.

In some embodiments, configuring the one or more sensors may comprise configuring a control unit to interface with the one or more sensors (e.g., to convert sensor readings into digital data). The control unit may be configured based on compatibility, processing power and memory capabilities to receive, process and transmit signals, or networking capabilities, such as Wi-Fi, Bluetooth, etc. for communicating with the AI subsystem. A control unit of the NI sensor system may also be configured based on processing power and system memory required for a microcontroller to process signals, networking capabilities (e.g., Wi-Fi, Bluetooth) and compatibility with sensors.

In some embodiments, at step/operation 1204, the computing entity configures one or more AI machine learning models based on NI data received from the NI sensor system. The NI sensor system may be configured to collect the NI data and provide the NI data to the AI subsystem. In some embodiments, data processing, such as data cleaning, normalization, and feature engineering, may be performed on the NI data to prepare the NI data for AI machine learning model training to ensure that one or more AI machine learning models receive reliable and meaningful input data. For example, the NI data may be (i) filtered to remove inaccuracies or inconsistencies, (ii) normalized to scale within a specific range suitable for one or more AI machine learning models, and (iii) extracted of features for generating one or more training/testing datasets that represent most relevant attributes for one or more AI machine learning models. In some embodiments, one or more training/testing datasets may be curated based on response data collected from the NI sensor system. Additionally, a custom dataset may also be curated based on user input.

In some embodiments, configuring the one or more AI machine learning models comprises using the NI data to train one or more AI machine learning models based on machine learning algorithms that are specific to a given application. The choice of algorithms may depend on application and a type of task to be performed. For example, machine learning algorithms may be selected to ensure that monitoring AI machine learning models are able to effectively monitor/interpret NI sensor system activities and controlling AI machine learning models are able to generate instructions to manage NI sensor system actions, aligning with user requests/overarching goals of a particular application in real-time. An AI machine learning model may be trained using response data collected from the NI sensor system to make them capable of making informed decisions based on real-time data. In some embodiments, a monitoring AI machine learning model may be trained to detect and correlate a natural being's response with a unit of change of a measured physical phenomenon. In some embodiments, a controlling AI machine learning model may be trained to generate instructions on how to manage and direct resources of the NI sensor system.

In some embodiments, at step/operation 1206, the computing entity generates, using the one or more AI machine learning models, one or more control instructions. In some embodiments, the one or more AI machine learning models may be trained, validated, and deployed. In some embodiments, a monitoring AI machine learning model may be deployed to monitor and interpret NI sensor system activity. In some embodiments, an AI subsystem may receive real-time data from the NI sensor system and use a monitoring AI machine learning model to analyze the real-time data and make intelligent decisions. In some embodiments, a controlling AI machine learning model may be deployed to govern behavior of the NI sensor system. In some embodiments, the controlling AI machine learning model may generate control signals that instruct actuators in an NI actuator system to perform desired actions (e.g., guide natural beings to perform desired actions).

In some embodiments, at step/operation 1208, the computing entity configures an NI actuator system based on the one or more control instructions. In some embodiments, the actuator system may be setup or configured to communicate instructions generated by a controlling AI machine learning model to a natural being. The actuator system may comprise one or more actuators that are configured to communicate (e.g., acoustic, aromatic, etc.) with natural beings. In some embodiments, one or more actuators may be selected based actions to be performed by the natural beings deployed with the NI sensor system. For example, specific types of actuators may be suitable for conditioning/controlling/guiding specific natural beings for performing desired actions based on AI machine learning model instructions. As such, expected responses of natural beings to behavioral conditioning may be considered for selecting actuators. Pretrained natural beings may also be employed in NI sensor system. In some embodiments, configuring the one or more actuators may comprise configuring a control unit to interface with the one or more actuators (e.g., receive and convert control instructions into signals for the one or more actuators).

In some embodiments, the process 1200 may further comprise steps/operations where the computing entity monitors and optimizes the FI system. In some embodiments, the FI system may comprise a closed-loop feature that enables the FI system to respond dynamically to changing conditions and optimize functionality based on AI-driven insights. In some embodiments, mechanisms may be implemented in the AI subsystem to monitor the performance of the FI system and allow for manual user inputs as needed to optimize the FI system under user control. Updates and improvements to the one or more AI machine learning models may further enhance the efficiency and accuracy of the FI system over time.

### EXAMPLE EMBODIMENTS

In some example embodiments, an FI system may be configured to solve challenges associated with bee pollination. Bees derive nourishment from pollen and nectar, which are rich sources of proteins and carbohydrates. When a bee lands on a flower, the hairs on its body, owing to electrostatic forces, attract pollen grains—the male reproductive elements of the plant. As bees move from one flower to another, they inadvertently deposit this pollen onto the stigma—the female reproductive component of flowers. This transfer of pollen subsequently fertilizes the ovules, facilitating the development of seeds and fruits. Foraging bees carry the collected nectar and pollen back to their hive, where it is either consumed or stored for future use. The extent of pollination in a field is largely dependent on the foraging behaviors of bees, which are influenced by a mix of environmental conditions and the bees' genetic and behavioral characteristics.

A significant challenge in agriculture is guaranteeing sufficient pollination for crops that rely on insect pollinators, such as apples, sunflowers, strawberries, and almonds. Pollination in expansive open fields is typically facilitated by insects attracted to the crops for nectar or pollen. Although newer farming methods like greenhouse and vertical farming are increasingly popular due to their ability to produce crops year-round, optimal spatial use, and controlled environments, these setups can restrict pollinator access. To overcome this, farmers often resort to manual pollination or the use of electromechanical aids. Techniques employing shakers with blowers have been introduced by researchers. More sophisticated solutions, such as autonomous drones and self-driving robotic technologies, have also been explored. Despite their effectiveness, the automation of such robotic pollination systems presents challenges, including complex functions like visual flower identification, manipulation, motion control, route navigation, and spatial mapping. These systems often require substantial energy. In contrast, natural pollinators such as bees are energy-efficient, adeptly navigating fields, identifying flowers, and transporting pollen due to their evolutionary adaptations.

In some example embodiments, an FI system is designed to enhance and support natural pollination efforts. Within this system, bees may be utilized as the biological actuators in an NI subsystem, which may be bolstered by an AI subsystem aimed at maximizing pollination efficiency and promoting the health of the bumblebee colonies. The FI system may enhance pollination by monitoring the bee visits across the field and improves disease control by continuously monitoring the bees while reducing human interference by automating beekeeping tasks. The FI system may also be setup to control or provide artificial light and ventilation in case of indoor farming to enhance forging activity of the bees. Honeybees or bumblebees may take the role of living beings in NI. AI takes the role of monitoring and controlling the bees.

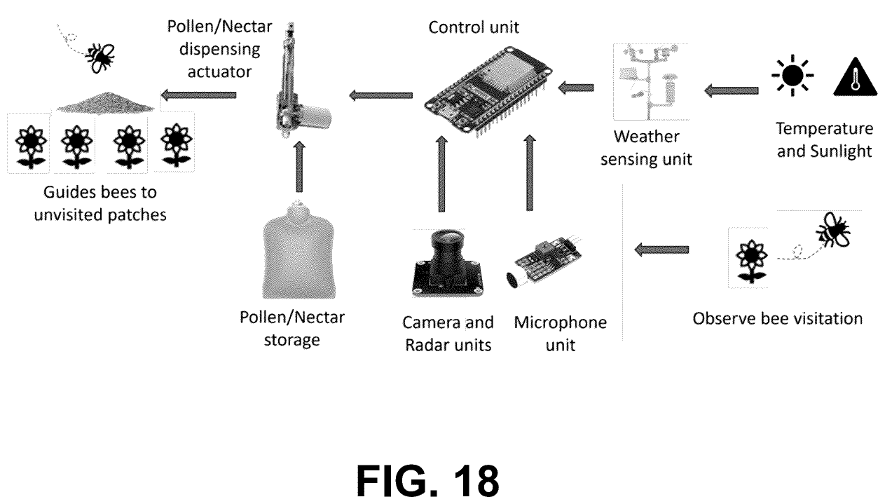

In some example embodiments, an FI system may be configured in field of flowering plots which are divided into smaller patches. The smaller patches may be installed with sensor and actuator packs. The sensor pack may comprise audio and visual sensors such as microphones, cameras, radars along with components as depicted in FIG. 18. In some embodiments, the actuator pack may comprise electromechanical dispensers with artificial food supplies including nectar and pollen. The sensors (e.g., microphone array units along with cameras for video capturing and radar/light detection and ranging (LiDAR) units for precise insect detection) may be strategically placed to sense surrounding patches. Similarly, actuators that dispense nectar/pollen may be placed at these locations.

Table 3 presents the foraging factors measured by the sensor pack. An increase in bee foraging activity correlates with higher visitation metrics, leading to enhanced pollination rates across the field.

TABLE 3

| Variable | Description | Metric |
|---|---|---|
| Foraging period | Amount of time available for foraging trips | Visitation |
| | [hours] daily defined by the weather (hours | |
| | of sunshine on days with a maximum | |
| | temperature > 15° C.) | |
| Completed foraging trips | Total number of completed foraging trips | |
| | divided by 103 for a given day | |
| Trips per hour of | Number of foraging trips of foragers per hour | |
| sunshine | sunshine divided by 103, per day | |
| Total visits per day | Total number of visits across all patches on a | |
| | given day | |
| Total visits per patch | Total number of visits throughout the | |
| | duration in a given patch | |
| Detected patches | Number of patches detected by the scouting | Coverage |
| | bees | |
| Covered area in km² | Distance covered by all bees in the | |
| | simulation | |
| Broodcare (%) | Relative ratio of brood size to the maximum | Colony health |
| | nursing force | |
| Honey and pollen stores | Amount of honey and pollen stored in the | |
| in kg | hive | |
| Colony size | Total number of adult bees (includes in-hive | |
| | worker bees and foragers) | |

Evaluating changes in pollination effectiveness due to foraging activities involves an intricate analysis of several interacting variables. In this context, a pollination improvement index (PII) may be used that integrates metrics of field coverage and visitation. The PII is mathematically expressed as:

$$PII = {W}_{1} ( {Δ}_{P D} ) + {W}_{2} ( {Δ}_{D V} ) \qquad \underline{Equation 1}$$

where ΔPD denotes the changes in patch detection and ΔDV represents alterations in daily visits, with W1 and W2 as the corresponding normalized weights for these metrics. Both factors positively impact pollination efficiency, hence W1 and W2 are assigned positive values. Moreover, the simulator also tracks metrics related to colony health such as “broodcare,” “honey and pollen stores,” and “colony size.” These are critical for assessing the overall health of the colony but are not encapsulated within the PII computation.

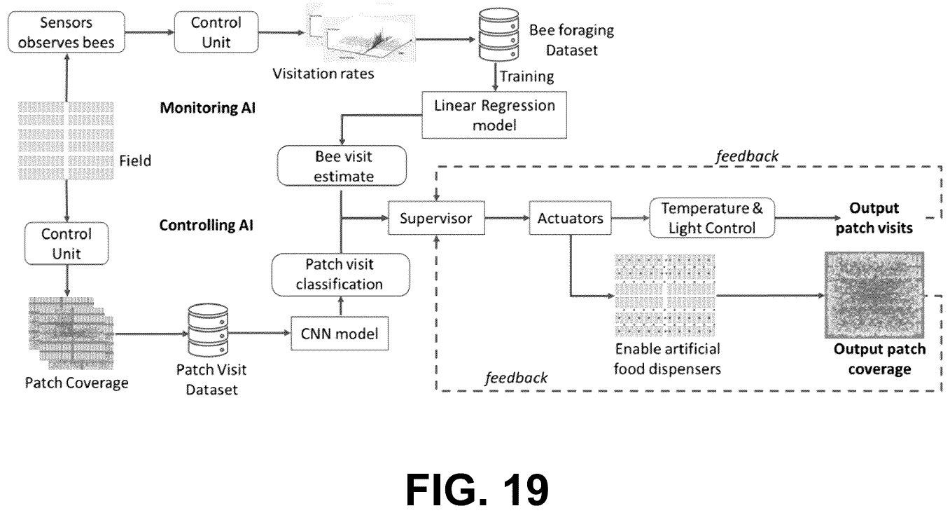

FIG. 19 represents the block diagram of the AI subsystem implemented to monitor and control the bee visitation to enhance pollination over the targeted field. As the sensor data from an NI subsystem is processed, a trained AI machine learning model based on convolutional neural networks (CNN) may be deployed to classify coverage across the field into three categories such as “low,” “normal,” or “high.” Data from a weather sensing unit may be used to train a regression AI model that may predict bee estimated visitation based on natural parameters. At this stage, the supervisor may annotate the patches with either low or normal coverage based on the output from the CNN model and then compare an estimated visitation against a target coverage to formulate a loss function. The AI subsystem may be tasked with enhancing the performance of this loss function by deploying appropriate actuators. Within this agricultural setting, the actuators may deploy pheromone sprays at specific sites or the deployment of nectar/pollen dispensers. The actuators may be activated at patch locations with low coverage to attract bees by serving as localized sources for nectar or pollen.

As depicted in FIG. 19, a feedback loop may allow the supervisor to fine-tune the activation of food patches throughout the field to optimize coverage. In the AI subsystem, the CNN model may be configured as the principal controlling model, while a linear regression model may be configured as the monitoring model. The regression model, denoted as R (x), may analyze the monitoring data, where x represents an input vector inclusive of parameters such as temperature, hours of sunlight, and distance from the beehive. The model's output, denoted as \hat{V}, may represent an estimation of the number of bee visits for a particular set of input parameters:

$$\hat{V} = R ( x ) \qquad \underline{Equation 2}$$

\hat{V} may comprise a predicted count of bee visits based on specified conditions. The prediction accuracy may be evaluated by comparing the predicted visitation, \hat{V}=R (x), against actual visitation data, V_{act}. A lower discrepancy between \hat{V} and V_{act} may indicate a more accurate observation of the NI subsystem by the FI system, as quantified by the observation accuracy, Acc_{obs}, defined in:

$$A c {c}_{o b s} = 1 - \frac{\vert {V}_{act} - \hat{V} \vert}{{V}_{act}} \qquad \underline{Equation 3}$$

C(I) may represent the CNN model where I may denote an image of the field. The CNN model may categorize each patch within the field into distinct visitation categories denoted as cₙ, which may range from high, normal, to low visitation.

Suppose V_{req} represents the number of visits necessary for optimal pollination. The discrepancy between the required number of visits and the estimated number established by the regression model may be expressed as:

$$Loss = \vert {V}_{r e q} - \hat{V} \vert \qquad \underline{Equation 4}$$

Equation 4 may be used to calculate the absolute difference between the required visits V_{req} and the estimated visits \hat{V}, which may help in determining the precision and performance of a pollination strategy as modeled by the AI subsystem.

In some example embodiments, enhancing bee coverage in agricultural settings may be significantly improved by coordinating the efforts of different bee species, such as honeybees and bumblebees. In some example embodiments, honeybees may be allowed to forage naturally across an area and utilizing an FI system, zones where visitation rates are suboptimal may be monitored and identified. Based on the identified zones, bumblebees may be strategically introduced to boost coverage.

When honeybees and bumblebees are both present in an agricultural setting, they may complement each other's strengths to maximize pollination efficiency. Bumblebees may take on the task of buzz pollinating flowers, while honeybees may focus on flowers that are easier to access. The presence of both types of bees may lead to more comprehensive pollination, resulting in higher fruit set and improved crop yields. In some crops, honeybees may indirectly benefit from the work of bumblebees. For example, after bumblebees have buzz pollinated a flower, some of the pollen may become more accessible, allowing honeybees to collect it more easily. By releasing bumblebees first, they may vigorously shake pollen loose from flowers like blueberries through their rapid wing vibrations. Following this, honeybees may be directed to previously occupied bumblebee locations. Such a sequence may increase the likelihood of honeybees collecting more freely available pollen, enhancing overall pollen dispersal. Additionally, the combined activity of both bee species can increase overall flower visitation rates, ensuring that a greater number of flowers are pollinated. As both bumblebees and honeybees interact within a field, the diversity of pollinators may be effectively increased along with the density of the pollinators. To improve cross-pollination, the systematic foraging patterns typically seen in honeybee behavior are disrupted by increasing bee diversity and density. Introducing a broader variety of bees may promote more random flower encounters due to differing foraging behaviors, thereby improving the chances of cross-pollination. The disclosed strategic disruption aims to create a dynamic and diverse pollination landscape where multiple bee species may contribute to a higher rate and quality of pollination.

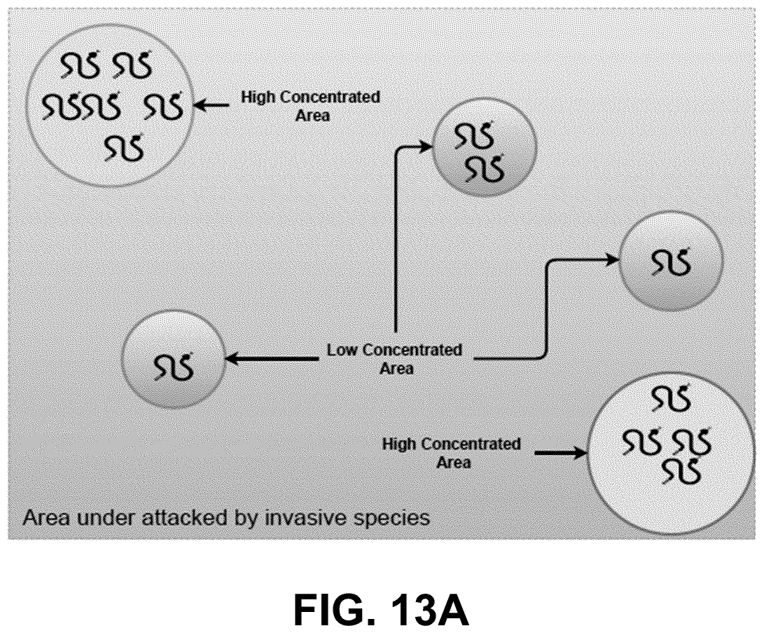

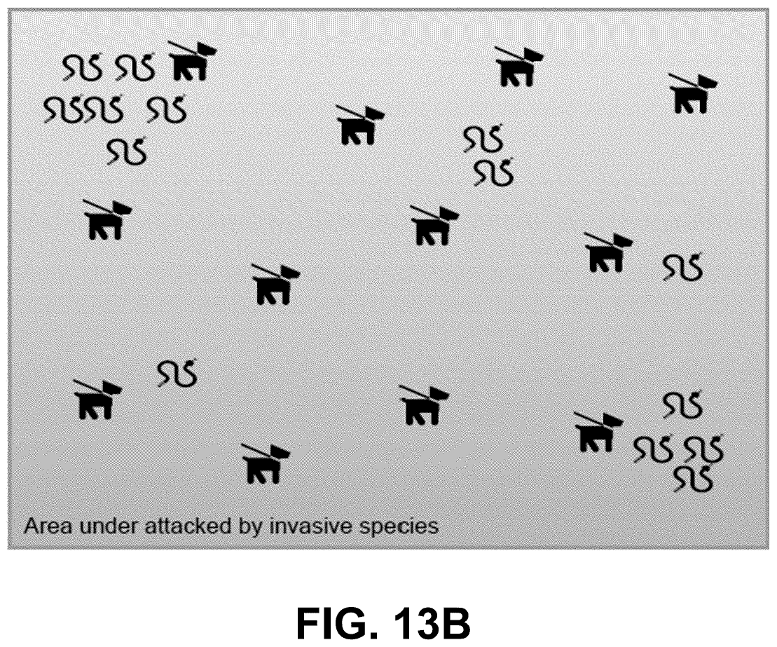

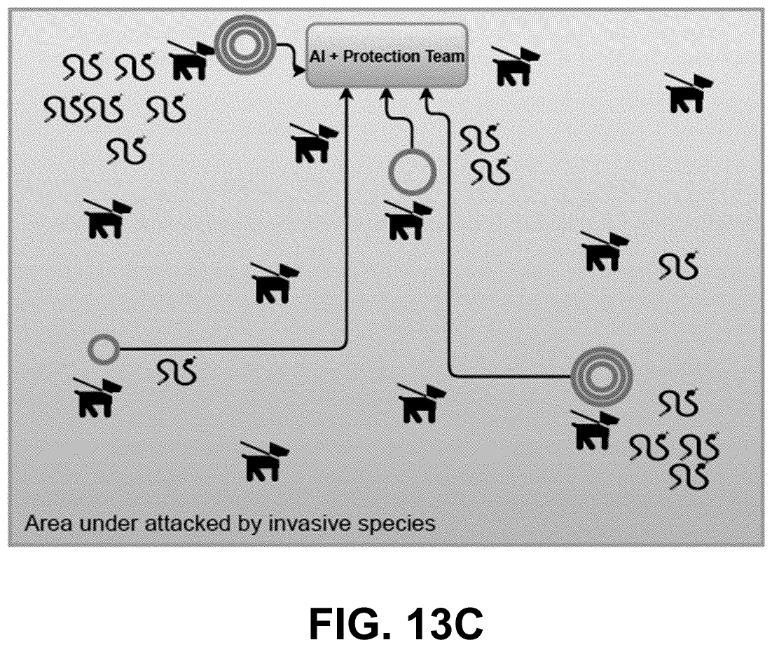

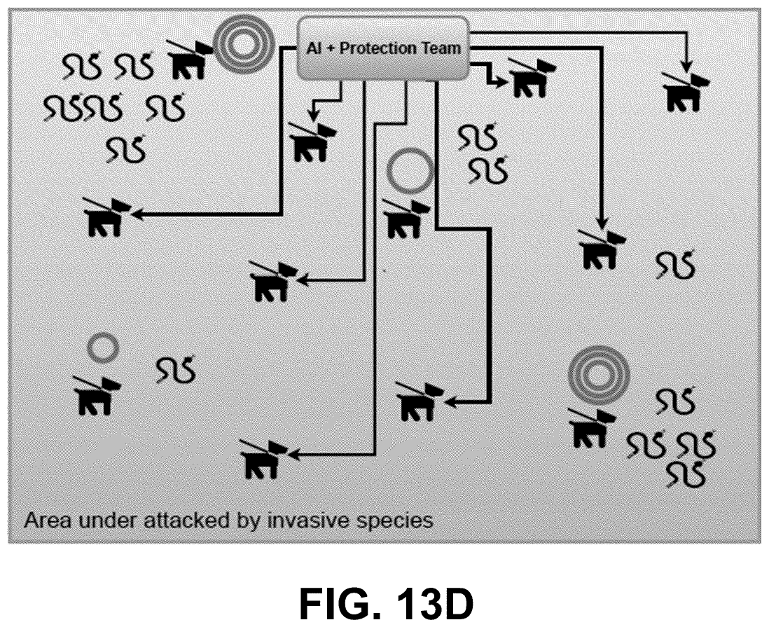

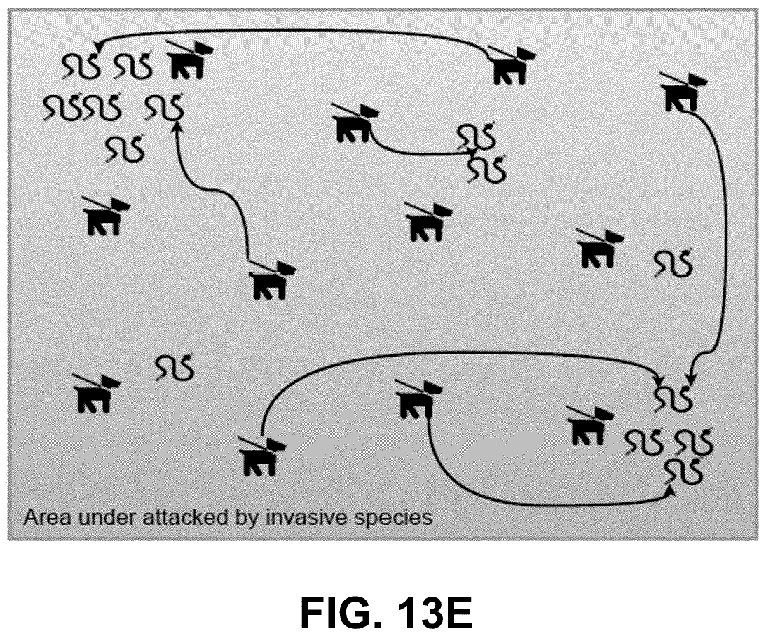

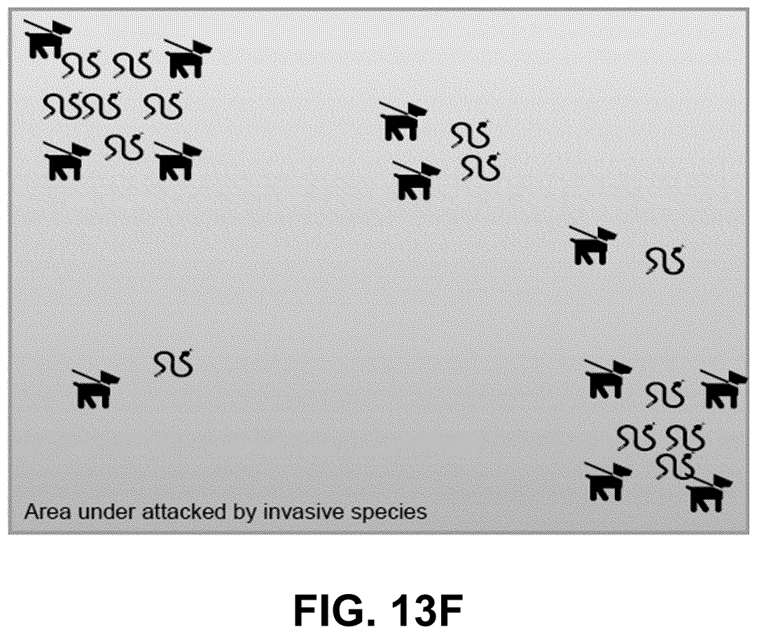

In some example embodiments, an FI system may be configured to maintain ecological balance and natural biodiversity by safeguarding native species against invasive ones, particularly those that propagate rapidly and may go unnoticed by humans. Detecting and controlling invasive species not visible to the naked eye poses an even greater challenge. The Burmese python serves as an example of such a species which has significantly impacted Florida's ecology after being introduced to the region in the 1980s, presumably through pet escapes or releases. Such large snakes may prey on native wildlife, including birds, mammals, and reptiles, and have been observed consuming endangered species, such as the wood stork and the Key Largo woodrat. Invasive species, such as the Burmese python, are known to disrupt the balance of ecosystems in which they are introduced. One of the reasons they are so disruptive is that, as depicted in FIG. 13A, they distribute unevenly throughout a particular area. Instead, they tend to concentrate on certain areas, leading to a disproportionate impact on the environment. This uneven distribution is often the result of factors such as favorable climate conditions, suitable food sources, and the absence of predators. As a result, the impact of invasive species on the environment can vary greatly depending on the local conditions and the specific behavior of the species in question. Given their camouflage-like pattern that blends into their surroundings, they are challenging to detect, but trained detection dogs have successfully sniffed out their scent and located them. By controlling the spread of invasive species like the Burmese python, natural ecosystems may be safeguarded, and native biodiversity may be preserved for future generations.

Trained detection dogs have proven to be valuable in detecting invasive species such as the Burmese python. However, it is important to note that their use is limited because they may only cover a limited area in a given time. That is, while they are effective, their range is constrained by the time and resources available. For instance, a single dog may be able to cover a few acres in a day, which is relatively small compared to the vast expanses of land where invasive species may be present. Moreover, the effectiveness of the dogs may be affected by environmental conditions, such as weather or terrain. Therefore, while trained detection dogs are an effective tool, using them in conjunction with other methods is crucial to maximize their effectiveness. This may include using AI or other technologies to identify areas where invasive species are likely present.

In some example embodiments, to detect invasive species, a FI system may comprise an NI subsystem that is configured to interface with dogs that are distributed evenly, as depicted in FIG. 13B. One of the benefits of using trained detection dogs to identify areas with invasive species is that dogs or their handlers may provide useful feedback on the concentration of the invasive species, as depicted in FIG. 13C. By analyzing the behavior of the dogs and the areas where they have been successful in detecting invasive species, a protection team can identify hotspots where these species are more concentrated.

The analysis data from an NI subsystem interfacing with the dogs may be provided to an AI subsystem and used to optimize resource allocation by focusing efforts on areas where invasive species are most prevalent. FIG. 13D depicts an example optimization of dogs interfaced with an NI subsystem in accordance with some embodiments with some embodiments discussed herein. Signals may be transmitted to idle dogs to move them to high-risk areas (e.g., as depicted in FIG. 13E). By doing so, the use of trained detection dogs and other resources on high-risk areas may be prioritized instead of dividing them equally among low-risk areas, ultimately preventing rapid propagation of these invasive species. As such the effectiveness of resources may be maximized (e.g., dogs are moved to high-risk area) and chances of detecting and controlling invasive species, such as the Burmese python, may be increased. Feedback data received from the dogs and their handlers may be provided to an AI subsystem to detect the concentration of invasive species in different areas.

In some example embodiments, the AI subsystem may determine the most effective places and increase the concentration of dogs in those areas to conduct their detection activities (e.g., as depicted FIG. 13F). By doing so, it may be ensured that the dogs are targeting high-risk areas and maximizing their chances of detecting invasive species. A feedback loop may be established between the NI subsystem (e.g., associated with the dogs) and the AI subsystem, which may allow for more efficient and effective use of resources in protecting natural ecosystems from invasive species.

In some example embodiments, to establish a feedback loop between trained detection dogs interfaced by the NI subsystem and AI technologies, training dogs may need to provide signals when they detect invasive species. These signals may be in the form of a particular type of bark or a specific pattern of movement that may be detected by sensors attached to their bodies. By analyzing these signals, AI technologies may learn to distinguish between the presence and absence of invasive species and provide feedback to the dogs. By tracking the dogs' activities in the aforementioned manner, it may be possible to gather data on a location and concentration of invasive species in different areas. Additionally, using sensors may help ensure that the dogs stay on task and detect invasive species to the best of their abilities. In some example embodiments, dog feedback may be used to determine an optimal deployment of resources in a field. For instance, if a certain area has a high concentration of invasive species, an AI machine learning model may identify the dogs best suited for the task based on their previous performance and physiological data, such as heart rate and respiration. This may ensure that the dogs are not overworked and are given adequate rest and recovery time to avoid exhaustion. By deploying the right dogs to the right areas, an AI subsystem may maximize the effectiveness of certain detection efforts and minimize the risk of burnout or injury to the dogs. The various example embodiments disclosed herewith may be used to ensure the dogs' safety and well-being and improve the overall efficiency of invasive species detection and control.

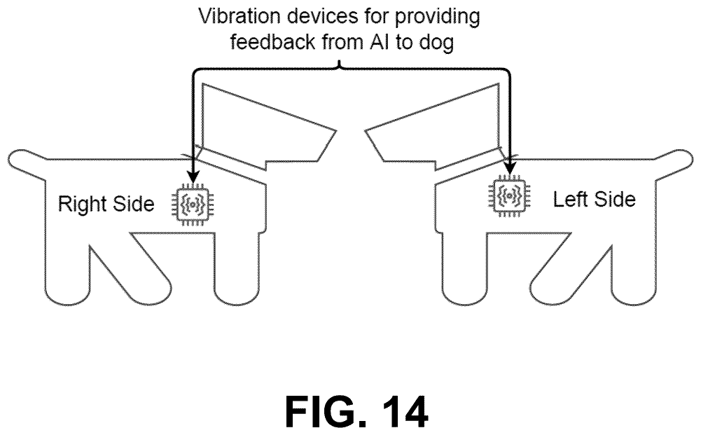

FIG. 14 depicts an example feedback device in accordance with some embodiments discussed herein. In some example embodiments, to provide feedback to the dogs based on the analysis of the AI, the NI subsystem may comprise vibration devices that are attached to each side of the dog's body. The AI subsystem may determine the dog's location using GPS and provide feedback to one of the devices on either side, indicating the direction the dog should move. The dogs may be trained to respond to the vibration of the sensor by moving in the corresponding direction using their previous training. Using such an approach, the dogs may be directed to high-concentration areas of invasive species, optimizing their efforts and reducing the chances of missing any areas.

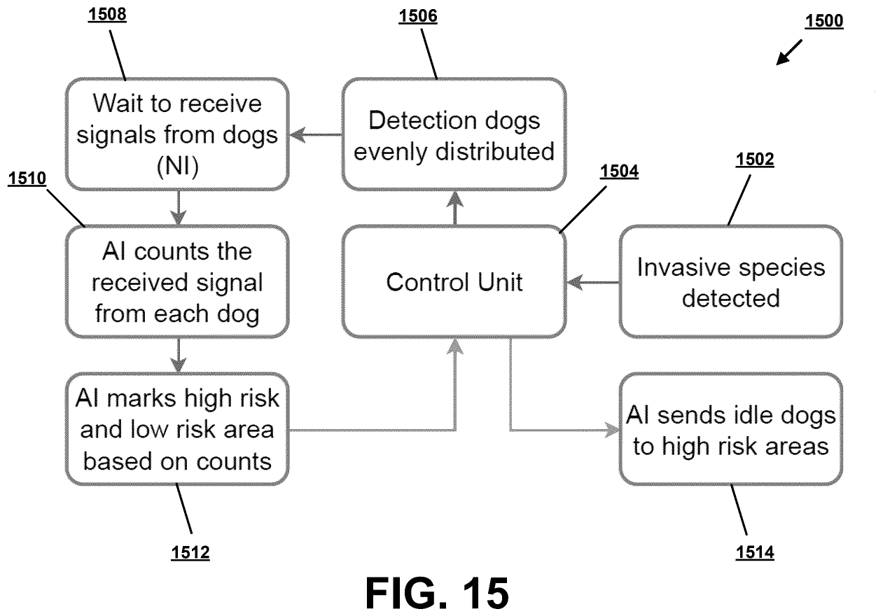

FIG. 15 depicts a flowchart of an example system architecture 1500 of invasive species detection and its feedback path in accordance with some example embodiments discussed herein. An FI system comprising NI and AI subsystems may be configured to operate autonomously without requiring human intervention. An FI system may be controlled by AI algorithms, which make decisions and execute actions based on the data gathered from various sensors. The core of the FI system may rely on a feedback loop established between the AI and NI subsystems. The FI system may comprise GPS sensors and vibration sensors configured to locate dogs and guiding them to their destinations.

A control unit 1504 may be configured to (i) receive a detection of an invasive species 1502, (ii) detect that dogs are evenly distributed 1506, (iii) wait to receive signals from the dogs via an NI subsystem 1508, (iv) count the number of signals received from the dogs 1510, and (v) mark high-risk and low-risk areas based on the counts 1512. Based on the high-risk and low-risk areas, the control unit sends idle dogs to the high-risk areas 1514.

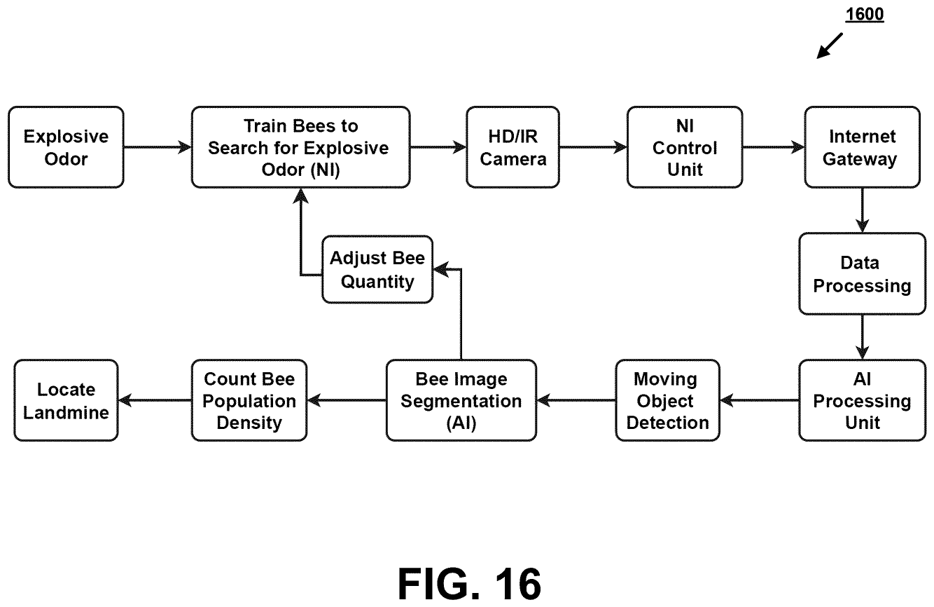

FIG. 16 depicts an example system architecture 1600 of landmine detection using bees in accordance with some example embodiments discussed herein. Landmines or explosive detection may be difficult for humans because landmines may easily detonate by direct pressure on the ground. To minimize the danger of activating landmines, non-contact sensors may be used. Ground penetrating radar (GPR), such as a GPR sensor, and a nuclear quadrupole resonance (NQR) spectrometer carried on a flying machine may be deployed to help remotely detect the landmines. However, the aforementioned sensors are subject to high energy consumption and low signal-to-noise ratio when the landmine is surrounded by other metals buried in the ground. In some example embodiments, trained flying insects with a strong sense of smell may be deployed with an NI subsystem to sense the odor of landmine vapor. Accordingly, a system that uses the sniffing ability of bees and artificial machine intelligence may significantly improve the safety and accuracy of locating landmines or explosives.

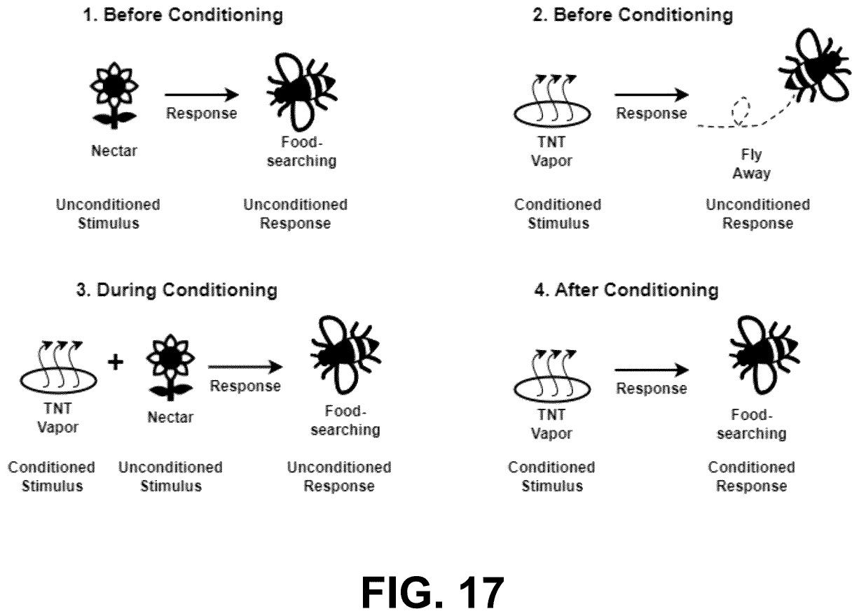

FIG. 17 depicts an example conditioning process for training an individual bee to associate trinitrotoluene (TNT) vapors with reward (nectar) in accordance with some example embodiments discussed herein. Insects, such as bees, have strong sniffing abilities, which can be adapted to detect the odor of chemicals from explosive vapors. Though bees are naturally drawn to food sources like the nectar they consume, they can be trained to learn to search for the smell of explosives. The conditioning process may present bees with a combination of their food sources and the odor of explosive vapors. After being exposed to a mixture of both odors, the bees may be able to associate the odor of the explosive vapors with their food and eventually exhibit unconditional food-searching responses to the explosive odor. Conditioned bees may be sent to a landmine field where the bees may be attracted to the odor of explosive vapor and move in circles near areas where the explosives are possibly buried. Sensors, such as high-definition (HD) and infrared (IR) cameras may then be used to monitor and detect the presence of bees. An HD camera may be used to acquire image data of the bees' responses during the day and IR cameras with IR reflectors may be applied on the bees at night when it is dark. Multiple cameras may be possibly used to capture images of individual bees, given that the size of each bee is much smaller than a landmine field.

Since bees are tiny and tend to move in circles, to capture their presence, it may be necessary to improve the image contrast of the bees by removing the background, which may remain constant. An example background removal method comprises subtracting the pixels between two consecutive images. Through background removal, identical non-moving parts of two images may be subtracted out with the pixels of moving parts of the two images left.

To enable a computer system to automatically identify individual bees in each new input image, a deep learning model, such as mask region-based convolutional neural network (R-CNN) may be used, for instance, segmentation. By training an AI machine learning model with labeled image data that contain bees, the AI machine learning model may help detect and segment out bee targets from an image and automatically generate spatial coordinates of the targets.

The number of bees attracted to each location may be counted to create a spatial map of bee population density. The location with the highest population density may correspond to where a landmine is located.

One problem with using a moving object detection algorithm is being able to distinguish bees from other moving objects, such as trees or flowers in the wind and other insects. To minimize the effect of this problem, the pattern size of moving bees in the images may be made significantly larger than the other moving objects. In this way, when detecting multiple moving object patterns at different locations, the image patterns of the largest size should be the moving bees. Since the pattern size of each moving object is determined by how much difference is between two images, more bees may be added, or the bees may be trained to move more dramatically to enlarge their pattern size in an image after background removal to improve the contrast of the bees in the images.

In some example embodiments, the natural intelligence of bees may be used to train the AI inside drones. By closely studying the behavior of bees and using this as a basis for training the ANN inside drones, a more effective and efficient approach to pollination may be achieved. The trained ANN may help to overcome the issues facing bee pollination, such as declining populations, difficulty in pollinating certain crops, and the impact of pesticides and other chemicals. The drone, equipped with the trained ANN, can navigate fields and identify the best paths to follow for efficient pollination. This approach provides a more reliable and efficient source of pollination and reduces the impact on the environment and human health. Using technology to supplement or replace bee pollination can ensure a sustainable future for agriculture while protecting the natural world.

By combining the natural intelligence of bees with the AI of drones, the unique strengths of both may be leveraged. Bees are excellent at detecting and navigating flowers and transferring pollen from one flower to another. On the other hand, drones can provide a more targeted and precise approach to pollination, ensuring that all areas of a crop are effectively pollinated. By combining both strengths, a more effective and efficient approach to pollination may be achieved than either could achieve alone.

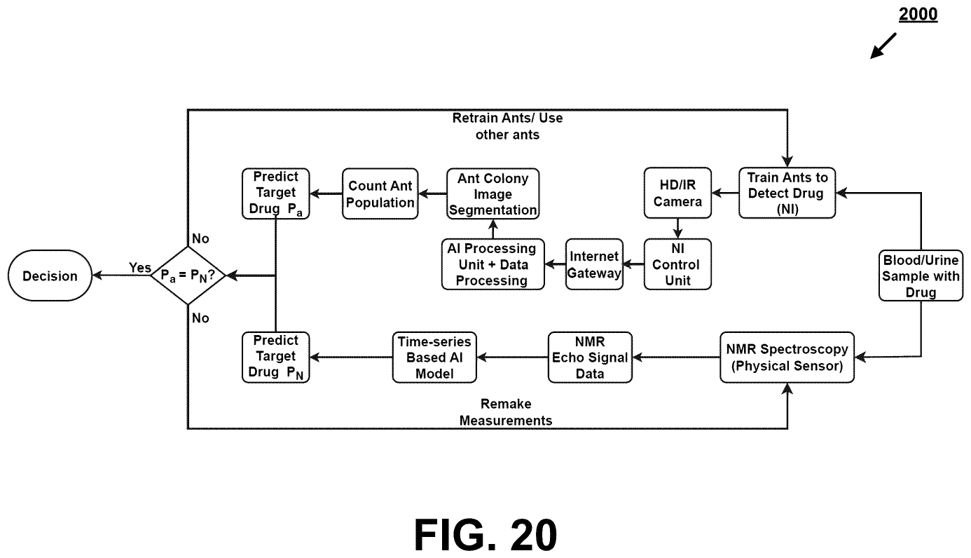

FIG. 20 depicts an example system architecture 2000 of drug testing using ants' sense of smell in accordance with some example embodiments discussed herein. In some example embodiments, ants may be conditioned to detect cancer cells and morphine. The ant's sense of smell is around 100 times more sensitive than a human's and may be the sharpest among all insects. Through training using a conditioning method, such as the one depicted in FIG. 17, an ant may be deployed to sniff out the “odorless” liquid version of morphine. Compared with more than a half year's training period of a typical sniffing dog for detecting drugs, it takes much less time, about 30 minutes, to train an ant to associate the smell of liquid morphine with its food source. Since ants are also addicted to drugs like humans or mammals, the training frequency needed to reinforce the reward association behavior can be significantly reduced with high detection accuracy.

Accordingly, an FI system may leverage the sniffing ability of ants to conduct opioid testing and detect its misuse. A testing procedure can be performed by sending a group of conditioned ants to a sample of human blood or urine to detect misuse of a specific target drug. Apart from liquid morphine, the drug can be other illegal drugs in liquid form if the classical conditioning is appropriately implemented on individual ants. Drug powders may be dissolved in water so that the concentration is not too high to inadvertently harm the ants, which are genetically different from humans. By properly training ants to detect illegal drugs, high accuracy may be achieved in detecting misuse of the drugs from human blood or urine. Detection accuracy may be further improved by combining the ant's sensor with a physical sensor and machine intelligence.

Illegal drugs in a sample of human blood or urine can also be identified through the conventional method of nuclear magnetic resonance (NMR) spectroscopy. NMR spectrometer can be used to acquire signals of different NMR parameters such as echo signal amplitude and T1/T2 relaxation time of the blood or urine sample that contains the specific illegal drug substance and then use an AI machine learning model to automatically predict possible misuse of a certain drug. An AI machine learning model such as the Linear regression method, KNN with dynamic time warping or Long Short-Term Memory (LSTM) may be selected for best time-series classification performance. The AI machine learning model may be trained with numerous NMR signal data collected from blood or urine samples that contain various chemical or drug substances with similar odor and color, which can be easily acquired from the market or prescribed from medical clinics. A fusion of an NMR spectroscopy supported by an AI machine learning model with the ant's sniffing sensor may help mutually identify possible mistakes in drug detection. The mistakes in the NMR spectroscopy and the ant sensing systems can then be corrected sequentially to reinforce the accuracy of decision-making in drug misuse.

Some insects, such as bees and wasps, have exceptional sensory capabilities, including detecting odors and distinguishing various scents. With proper training, these insects may identify specific odors associated with contraband or suspicious substances within packages. Trained bees or wasps may indicate the presence of suspicious materials by exhibiting a specific response or behavior using their natural olfactory skills. Conventionally, sniffer dogs are used to screen packages that might contain illegal substances. However, several drugs, like recreational cannabis, have been legalized or decriminalized in multiple states, raising complications for law enforcement. Police can no longer rely on sniffer dog alerts because retraining sniffer dogs to ignore cannabis is expensive, time-consuming, and tedious.

In an unconventional approach, trained insects may be utilized to identify the potential packages containing illegal substances. By training bees and integrating them into a specially designed system, an efficient and reliable method may be provided for identifying suspicious packages that require further scrutiny.

Training bees to identify specific scents may involve a systematic approach to capitalize on their natural foraging instincts. This systematic approach may be significantly faster and cheaper than training a sniffer dog. For example, a conditioning process may comprise a 30 second inter-trial interval where an odor is presented as a conditioned stimulus for 8 seconds and a mild electric shock (pulses of 200 ms at 10V and 1.2 Hz) is applied every 2 seconds after the release. The conditioning process associates a target odor, such as an illegal substance, with a reward stimulus like sugar water. Bees may quickly learn to recognize and associate the scent with a positive outcome. This process is reinforced through repetition until the bees reliably respond to the target odor.

Training wasps may require a slightly different approach where the wasps are only provided with water for 48 hours before training. This approach trains the food-deprived wasps by exposing them to a concentrated target odor and sucrose water, providing a positive feeding experience.

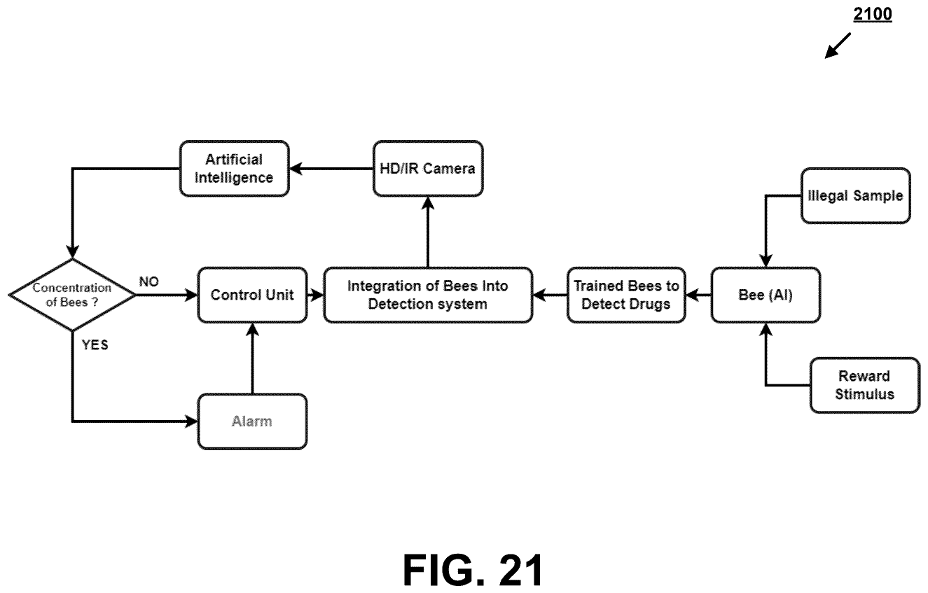

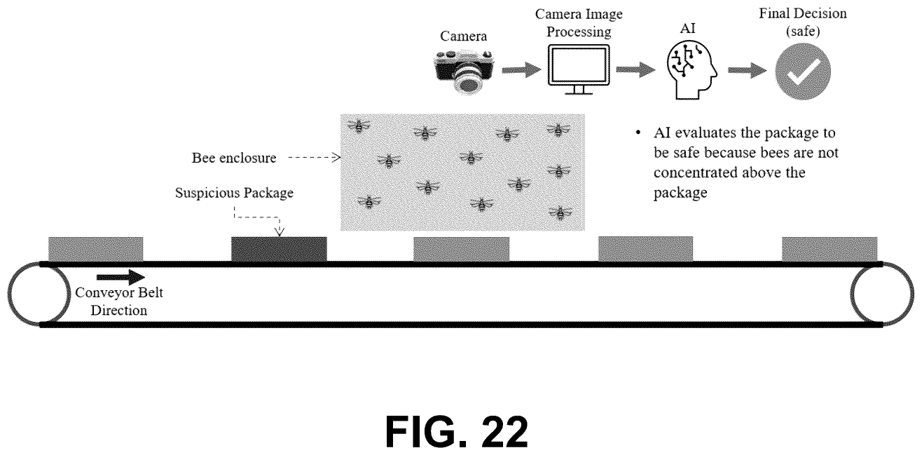

FIG. 21 depicts a flow chart of an example process 2100 for detecting drugs in accordance with some example embodiments discussed herein. Trained bees may be integrated into a drug detection system to detect illegal substances at a post office. The detection system may comprise a special enclosure, camera, image processing unit, and an AI machine learning model. The enclosure containing the insects may be made of a transparent material that allows the camera to see the bees' motion. Packages may be placed on a moving belt to streamline the process of continuous inspection, as depicted in FIG. 22. The enclosure may be strategically positioned along the belt, creating a confined space for the insects to navigate. The enclosure may comprise a porous floor allowing the insects to sniff the package right underneath without giving enough space to escape from the container.

Trained insects may fly freely inside the enclosure as the packages move through the system. Their exceptional olfactory capabilities enable them to detect even trace amounts of illegal substances. When these insects identify a suspicious package, they naturally gravitate toward it due to the odor recognition learned during training. A camera constantly monitors the activities of these trained insects. The camera output is fed to an image processing pipeline.

Advanced computer vision techniques may be utilized in an image processing pipeline to track the movement and density of bees within the chamber. An AI system may be deployed to monitor the concentration of insects around the packages to facilitate efficient detection. By analyzing the concentration levels, the AI system can identify packages that attract more insects, indicating a higher likelihood of containing illegal substances.

FIG. 22 depicts a low concentration of bees around packages inside the chamber where the AI system does not send any signal for detecting suspicious packages in accordance with some example embodiments discussed herein.

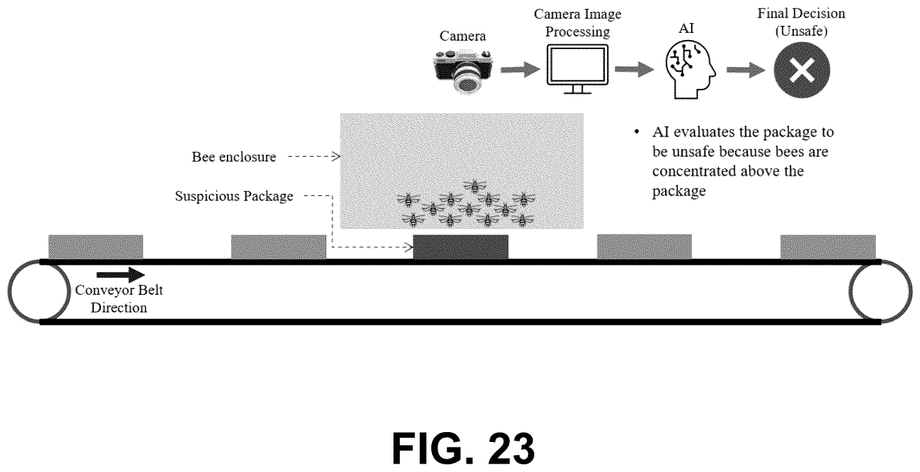

FIG. 23 depicts a high concentration of bees around packages inside the chamber where the AI system sends an alarm signal to detect suspicious packages in accordance with some example embodiments discussed herein.

When the AI system detects a significant increase in bee concentration around a particular package, it may alert authorities to review it more carefully. Additional security measures, such as manual inspections or advanced scanning technologies, may be implemented to verify the presence of illegal substances. The AI system's ability to provide an initial filter significantly streamlines the screening process, saving valuable time and resources.

Current state-of-the-art package scanners utilize X-ray or neutron radiography technology to detect contraband. These scanners are costly and necessitate a human operator to assess the safety of a package solely based on a radiographic image. In the image, dense materials like metals appear bright or white, while organic materials like clothing or paper appear darker or grayish. Although the X-ray image can provide clear object shapes inside the package, it does not offer any information about the content or material properties. By incorporating neutron information, these scanners employ a color gradient to highlight material differences for the operator. Together, X-ray and neutron technology enable a trained operator to discern the materials of objects inside a package. However, the limited resolution makes interpreting scanner results increasingly challenging for densely packed containers.

An AI system has the potential to assume the responsibility of labeling suspicious packages and relieving human operators of their tasks. Nevertheless, an AI system may be trained on a finite dataset, which makes it susceptible to misclassifying packages. In the rapidly evolving modern times, new materials and drugs are constantly being discovered. Innovative substances may not yet be known or recognized by AI systems. Since AI relies on pre-existing data and training, it may lack awareness of these newly discovered materials or drugs. As a result, AI may struggle to classify or identify them within packages or other contexts accurately. This drawback of AI highlights the importance of natural intelligence/expertise and ongoing updates to AI systems to ensure they stay up to date with the latest advancements in materials and drugs. Collaborative efforts between insects and AI can help bridge this knowledge gap and enhance the effectiveness of package scanning technology in the face of evolving substances.

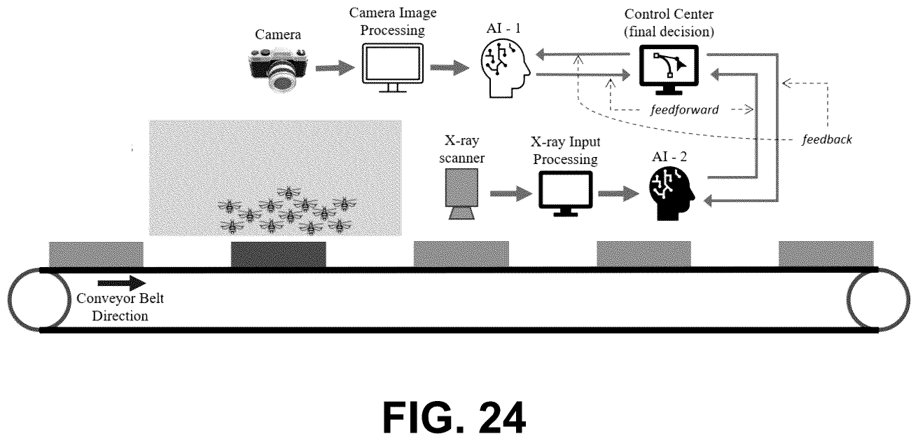

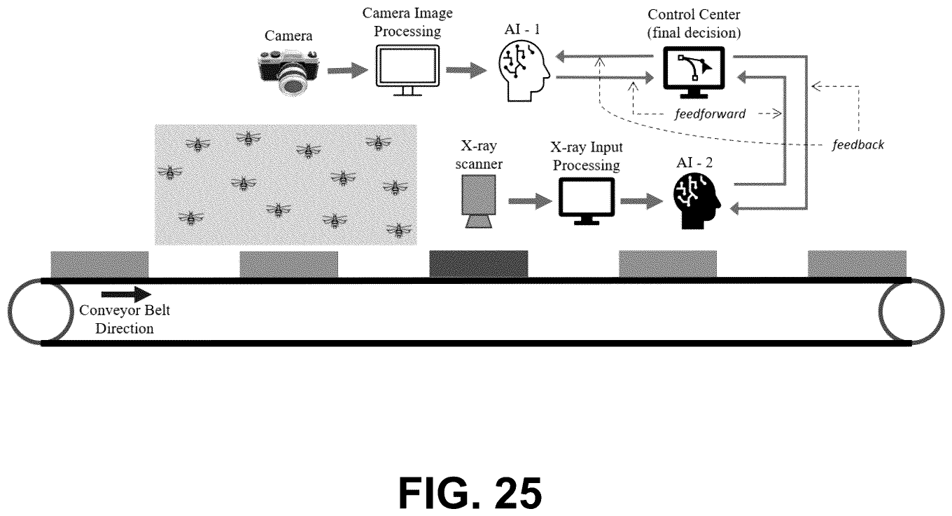

FIG. 24 depicts conventional package screening technology in conjunction with natural intelligence in accordance with some example embodiments discussed herein. Packages are screened sequentially. A package is passed from the conventional scanner where an AI system may try to correlate it with a pre-existing dataset and provide a decision. Later, the package is subjected to a specially designed system containing insects. The AI system may also decide on the same package based on the insects' response, as depicted in FIG. 25.

When screening packages, if trained bees display a response indicating suspicion towards a particular package while the AI does not trigger any alerts, a protocol may be implemented to validate the accuracy of their decisions. In such cases, the package may undergo additional scrutiny to determine its contents and verify if contraband or suspicious materials are present. This process may serve as a ground-truth assessment. Based on the outcome, both AI and bees may receive reinforcement in the form of feedback and adjustments to improve their decision-making accuracy. This iterative approach aims to enhance the overall effectiveness of the screening system by leveraging the strengths of both AI technology and trained bees' sensory capabilities while also accounting for any potential limitations or discrepancies between their responses.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A system comprising:
one or more natural intelligence (NI) subsystems that comprise one or more sensors and one or more actuators, wherein the one or more NI subsystems are configured to (i) generate sensor data that is associated with one or more responses of one or more natural beings to one or more stimuli via the one or more sensors and (ii) manage the one or more natural beings based on one or more instructions via the one or more actuators; and
one or more artificial intelligence (AI) subsystems that are coupled to the one or more NI subsystems, wherein the one or more AI subsystems comprise one or more AI machine learning models that are configured to (i) receive the sensor data from the one or more NI subsystems and (ii) generate the one or more instructions based on the sensor data.

2. The system of claim 1, wherein the one or more NI subsystems are configured to digitize one or more actions or responses of the one or more natural beings to the one or more stimuli.

3. The system of claim 1, wherein the one or more AI machine learning models are trained to interpret actions associated with the sensor data.

4. The system of claim 1, wherein the one or more AI subsystems are configured to monitor the one or more NI subsystems by correlating activity associated with the sensor data with a quantized unit of change in a measured physical phenomenon associated with the one or more stimuli.

5. The system of claim 1, wherein the one or more AI subsystems are coupled to the one or more NI subsystems in an one-to-one configuration, a plurality of AI subsystems to one NI subsystem configuration, a one AI subsystem to a plurality of NI subsystem configuration, or a plurality of AI subsystems to a plurality of NI subsystems configuration.

6. The system of claim 1, wherein the one or more AI subsystems are configured in an AI monitoring NI configuration and comprises a model supervisor that is configured to train a monitoring AI machine learning model from the one or more AI machine learning models based on the sensor data.

7. The system of claim 6, wherein the monitoring AI machine learning model is trained to monitor and provide an estimated meaningful observation of activity or behavior that is associated with the sensor data.

8. The system of claim 1, wherein the one or more AI subsystems are configured in an AI controlling NI configuration and comprises a model supervisor that is configured to (i) train a controlling AI machine learning model based on output from a monitoring AI machine learning model and (ii) generate, using the controlling AI machine learning model the one or more instructions.

9. A system comprising:
a perception layer that comprises a natural intelligence (NI) subsystem that interfaces with one or more natural beings via one or more sensors and one or more actuators;
a processing layer that comprises an artificial intelligence (AI) subsystem configured to (i) receive data from the NI subsystem and (ii) train one or more AI machine learning models to monitor or control the NI subsystem based on the data;
a network layer that is configured to provide the data from the NI subsystem to the AI subsystem; and
an application layer that is configured to (i) provide one or more inputs to the AI subsystem for processing by the one or more AI machine learning models and (ii) provide an interface for interacting with output generated by the one or more AI machine learning models based on the one or more inputs.

10. The system of claim 9, wherein the NI subsystem is configured to collect data from a physical environment or interact with a physical world via the one or more natural beings by using the one or more sensors.

11. The system of claim 9, wherein the AI subsystem is further configured to train the one or more AI machine learning models to (i) understand or predict behavior of the one or more natural beings and (ii) generate one or more instructions to control the one or more natural beings via the one or more actuators.

12. The system of claim 9, wherein the NI subsystem comprises a natural beings hosting component that is configured to maintain the one or more natural beings.

13. The system of claim 9, wherein the one or more sensors are configured to generate the data based on a response of the one or more natural beings to one or more stimuli.

14. The system of claim 9, wherein the data is associated with one or more physical phenomena.

15. The system of claim 9, wherein a monitoring AI machine learning model of the one or more AI machine learning models is trained to generate an output in response to a change in a physical phenomenon based on sensing data generated by the one or more sensors with respect to the one or more natural beings.

16. The system of claim 15, wherein the one or more actuators are configured to manage the one or more natural beings based on the output.

17. The system of claim 15, wherein a controlling AI machine learning model of the one or more AI machine learning models is configured to generate one or more instructions based on the output.

18. The system of claim 17, wherein the AI subsystem is configured to provide the one or more instructions to the one or more actuators.

19. The system of claim 9, wherein the one or more sensors comprise one or more infrared cameras or one or more wide-frequency-range tuned microphones.

20. The system of claim 9, wherein the one or more actuators comprise one or more speakers, one or more light-emitting diodes, one or more olfactory synthesizers, or one or more food dispensers.
